(19) United States
(12) Patent Application Publication
(10) Pub. No.: US 2020/0169726 A1
(43) Pub. Date: May 28, 2020

(54) METHOD AND DEVICE FOR INDUCING MOTION PREDICTION INFORMATION

(71) Applicant: Electronics and Telecommunications Research Institute, Daejeon (KR)

(72) Inventors: Youn-Hee KIM, Daejeon (KR); Jin-Wuk SEOK, Daejeon (KR); Myung-Seok KI, Daejeon (KR); Sung-Chang LIM, Daejeon (KR); Hui-Yong KIM, Daejeon (KR); Jin-Soo CHOI, Daejeon (KR)

(73) Assignee: Electronics and Telecommunications Research Institute, Daejeon (KR)

(21) Appl. No.: 16/088,464

(22) PCT Filed: Apr. 7, 2017
(86) PCT No.: PCT/KR2017/003834

§ 371 Date: Sep. 26, 2018

(30) Foreign Application Priority Data
Apr. 8, 2016 (KR) 10-2016-0043249
Apr. 7, 2017 (KR) 10-2017-0045245

(51) Int. Cl. H04N 19/105; H04N 19/137; H04N 19/159; H04N 19/176

(52) U.S. Cl. CPC H04N 19/105; H04N 19/176; H04N 19/159; H04N 19/137

(57) ABSTRACT

Disclosed herein are a method and apparatus for deriving motion prediction information and performing encoding and/or decoding on a video using the derived motion prediction information. Each of an encoding apparatus and a decoding apparatus generates a list for inter prediction of a target block. In the generation of the list, whether motion information of a candidate block is to be added to a list is determined based on information about the target block and the motion information. When the motion information passes a motion prediction boundary check, the motion information is added to the list. By means of the motion prediction boundary check, available motion information for prediction of the target block is selectively added to the list.

### TECHNICAL FIELD

The following embodiments generally relate to a video decoding method and apparatus and a video encoding method and apparatus and, more particularly, to a method and apparatus for deriving motion prediction information and performing encoding and/or decoding on a video using the derived motion prediction information.

This application claims the benefit of Korean Patent Application Nos. 10-2016-0043249, filed Apr. 8, 2016, and 10-2017-0045245, filed Apr. 7, 2017, which are hereby incorporated by reference in their entirety into this application.

### BACKGROUND ART

With the continuous development of the information and communication industries, broadcasting services having High-Definition (HD) resolution have been popularized all over the world. Through this popularization, a large number of users have become accustomed to high-resolution and high-definition images and/or videos.

To satisfy users' demands for high definition, a large number of institutions have accelerated the development of next-generation imaging devices. Users' interest in Ultra High Definition (UHD) TVs, having resolution that is more than four times as high as that of Full HD (FHD) TVs, as well as High-Definition TVs (HDTV) and FHD TVs, has increased. As such interest has increased, image encoding/decoding technology for images having higher resolution and higher definition is required.

An image encoding/decoding apparatus and method may use inter prediction technology, intra prediction technology, entropy coding technology, etc. in order to perform encoding/decoding on high-resolution and high-definition images. Inter prediction technology may be a technique for predicting the value of a pixel included in a current picture using temporally previous pictures and/or temporally subsequent pictures. Intra prediction technology may be a technique for predicting the value of a pixel included in the current picture using information about pixels in the current picture. Entropy coding technology may be a technique for assigning short code to symbols that occur more frequently and assigning long code to symbols that occur less frequently.

In image encoding and decoding, prediction may mean the generation of a prediction signal similar to an original signal. Prediction may be chiefly classified into prediction that refers to a spatially reconstructed image, prediction that refers to a temporally reconstructed image, and prediction that refers to other symbols. In other words, temporal referencing may mean that a temporally reconstructed image is referred to, and spatial referencing may mean that a spatially reconstructed image is referred to.

Inter prediction may be technology for predicting a target block using temporal referencing and spatial referencing. Intra prediction may be technology for predicting the target block using only spatial referencing.

When pictures constituting a video are encoded, each of the pictures may be partitioned into multiple parts, and the multiple parts may be encoded. In this case, in order for a decoding apparatus to decode the partitioned picture, information about the partitioning of the picture may be required.

To improve encoding processing speed, pictures may be encoded in parallel using a parallel encoding method. Further, to improve decoding processing speed, pictures may be decoded in parallel using a parallel decoding method.

The parallel encoding method includes picture partitioning encoding methods. As the picture partitioning encoding methods, a slice-based picture partitioning encoding method and a tile-based picture partitioning encoding method are provided.

A conventional picture partitioning encoding method does not allow reference between segments of a partitioned picture in encoding that uses intra prediction. On the other hand, the conventional picture partitioning encoding method allows reference between segments of a partitioned picture in encoding that uses inter prediction.

Therefore, when it is desired to perform parallel encoding on each picture partition unit using the conventional picture partitioning encoding method, synchronization must be realized for each picture. The efficiency of parallel processing by the encoding apparatus in the case where synchronization is required for each picture is inevitably lower than that of parallel processing by the encoding apparatus in the case where synchronization is not required.

### DISCLOSURE

### Technical Problem

An embodiment is intended to provide a method and apparatus that prevent inter-segment referencing from occurring when a picture partitioned into segments is encoded or decoded.

An embodiment is intended to provide a method and apparatus that perform parallel encoding or parallel decoding on segments by preventing inter-segment referencing.

An embodiment is intended to provide a method and apparatus that perform encoding or decoding that does not refer to other segments when inter prediction is performed on a target block in one segment.

An embodiment is intended to provide a method and apparatus that generate a list of motion information so that other segments are not referred to when inter prediction is performed on a target block in one segment.

An embodiment is intended to provide a method and apparatus that allow only referencing to a region corresponding to inter prediction when encoding that uses inter prediction is performed.

An embodiment is intended to provide a method and apparatus that exclude motion information that causes a target block to refer to a location out of the boundary of a region from a list.

### Technical Solution

In accordance with an aspect, there is provided a list generation method for generating a list for inter prediction of a target block, including determining whether motion information of a candidate block is to be added to a list; and if it is determined that the motion information is to be added to the list, adding the motion information to the list, wherein whether the motion information is to be added to the list is determined based on information about the target block and the motion information.

The information about the target block may be a location of the target block.

Whether the motion information is to be added to the list may be determined based on a motion vector of the motion information.

Whether the motion information is to be added to the list may be determined based on a location indicated by a motion vector of the motion information applied to the target block.

The location indicated by the motion vector may be a location in a reference picture referred to by the target block.

If the location is present within a region, the motion information may be added to the list, whereas if the location is out of the region, the motion information is not added to the list.

The region may be a region of a slice including the target block, a region of a tile including the target block, or a region of a Motion-Constrained Tile Set (MCTS) including the target block.

If the location is not out of a boundary, the motion information may be added to the list, whereas if the location is out of the boundary, the motion information may not be added to the list.

The boundary may include a boundary of a picture.

The boundary may include a boundary between slices, a boundary between tiles, or a boundary between MCTSs.

An intra-prediction mode of the target block may be a merge mode or a skip mode.

The list may be a merge list.

An intra-prediction mode of the target block may be an Advanced Motion Vector Predictor (AMVP) mode.

The list may be a predictive motion vector candidate list.

The candidate block may include multiple spatial candidates and temporal candidates.

If the candidate block is available and the motion information of the candidate block does not overlap other motion information present in the list, the motion information of the candidate block may be added to the list.

Even if the candidate block is a first available candidate block, the motion information of the candidate block may not be added to the list when the information about the target block and the motion information satisfy specific conditions.

In accordance with another aspect, there is provided a list generation apparatus for generating a list for inter prediction of a target block, including a processing unit for determining whether motion information of a candidate block is to be added to the list, based on based on information about the target block and the motion information of the candidate block; and a storage unit for storing the list.

In accordance with a further aspect, there is provided method for setting availability of a candidate block for inter prediction of a target block, including determining whether the candidate block is available; and setting availability of the candidate block based on results of the determination, wherein the availability is set based on information about a target block and motion information of an object including the candidate block.

The object may be a Prediction Unit (PU).

Whether the candidate block is available may be determined based on a motion vector of the motion information.

Whether the candidate block is available may be determined based on a location indicated by a motion vector of the motion information applied to the target block.

If the location is present within a region, the candidate block may be set to be available, whereas if the location is out of the region, the candidate block may be set to be unavailable.

### Advantageous Effects

Provided are a method and apparatus that prevent inter-segment referencing from occurring when a picture partitioned into segments is encoded or decoded.

Provided are a method and apparatus that perform parallel encoding or parallel decoding on segments by preventing inter-segment referencing.

Provided are a method and apparatus that perform encoding or decoding that does not refer to other segments when inter prediction is performed on a target block in one segment.

Provided are a method and apparatus that generate a list of motion information so that other segments are not referred to when inter prediction is performed on a target block in one segment.

Provided are a method and apparatus that allow only referencing to a region corresponding to inter prediction when encoding that uses inter prediction is performed.

Provided are a method and apparatus that exclude motion information that causes a target block to refer to a location out of the boundary of a region from a list.

### DESCRIPTION OF DRAWINGS

FIG. 1 is a block diagram illustrating the configuration of an embodiment of an encoding apparatus to which the present invention is applied;

FIG. 2 is a block diagram illustrating the configuration of an embodiment of a decoding apparatus to which the present invention is applied;

FIG. 3 is a diagram schematically illustrating the partition structure of an image when the image is encoded and decoded;

FIG. 4 is a diagram illustrating the form of a Prediction Unit (PU) that a Coding Unit (CU) can include;

FIG. 5 is a diagram illustrating the form of a Transform Unit (TU) that can be included in a CU;

FIG. 6 is a diagram for explaining an embodiment of an intra-prediction procedure;

FIG. 7 is a diagram for explaining the locations of reference samples used in an intra-prediction procedure;

FIG. 8 is a diagram for explaining an embodiment of an inter-prediction procedure;

FIG. 8 is a diagram for explaining an embodiment of an inter-prediction procedure;

FIG. 9 illustrates spatial candidates according to an embodiment;

FIG. 10 illustrates the sequence of the addition of motion information of spatial candidates to a merge list according to an embodiment;

FIG. 11 illustrates the partitioning of a picture that uses tiles according to an embodiment;

FIG. 12 illustrates the partitioning of a picture that uses slices according to an embodiment;

FIG. 13 illustrates distributed encoding of a temporally-spatially partitioned picture according to an embodiment;

FIG. 14 illustrates the processing of a Motion-Constrained Tile Set (MCTS) according to an embodiment;

FIG. 15 illustrates a PU adjacent to the boundary of a slice according to an embodiment;

FIG. 16 illustrates a merge list according to an embodiment;

FIG. 17 is a flowchart of an inter-prediction method according to an embodiment;

FIG. 18 is a flowchart of a method for generating a merge list for inter prediction of a target block according to an embodiment;

FIG. 19 is a flowchart of a method for generating a predictive motion vector candidate list for inter prediction of a target block according to an embodiment;

FIG. 20 is a flowchart of a method for determining the availability of a candidate block for inter prediction of a target block according to an embodiment;

FIG. 21 illustrates a merge list to which a motion prediction boundary check is applied according to an embodiment;

FIG. 22 is a configuration diagram of an electronic device in which an encoding apparatus is implemented according to an embodiment; and

FIG. 23 is a configuration diagram of an electronic device in which a decoding apparatus is implemented according to an embodiment.

### BEST MODE

Detailed descriptions of the following exemplary embodiments will be made with reference to the attached drawings illustrating specific embodiments.

In the drawings, similar reference numerals are used to designate the same or similar functions in various aspects. The shapes, sizes, etc. of components in the drawings may be exaggerated to make the description clear.

It will be understood that when a component is referred to as being “connected” or “coupled” to another component, it can be directly connected or coupled to the other component, or intervening components may be present. Further, it should be noted that, in exemplary embodiments, the expression describing that a component “comprises” a specific component means that additional components may be included in the scope of the practice or the technical spirit of exemplary embodiments, but do not preclude the presence of components other than the specific component.

Respective components are arranged separately for convenience of description. For example, at least two of the components may be integrated into a single component. Conversely, one component may be divided into multiple components. An embodiment into which the components are integrated or an embodiment in which some components are separated is included in the scope of the present specification as long as it does not depart from the essence of the present specification.

Embodiments will be described in detail below with reference to the accompanying drawings so that those having ordinary knowledge in the technical field to which the embodiments pertain can easily practice the embodiments. In the following description of the embodiments, detailed descriptions of known functions or configurations which are deemed to make the gist of the present specification obscure will be omitted.

Hereinafter, “image” may mean a single picture constituting part of a video, or may mean the video itself. For example, “encoding and/or decoding of an image” may mean “encoding and/or decoding of a video”, and may also mean “encoding and/or decoding of any one of images constituting the video”.

Hereinafter, “video” and “motion picture” may be used to have the same meaning, and may be used interchangeably with each other.

Hereinafter, a target image may be an encoding target image that is the target to be encoded and/or a decoding target image that is the target to be decoded. Further, the target image may be an input image that is input to an encoding apparatus or an input image that is input to a decoding apparatus.

Hereinafter, the terms “image”, “picture”, “frame”, and “screen” may be used to have the same meaning and may be used interchangeably with each other.

Hereinafter, a target block may be an encoding target block that is the target to be encoded and/or a decoding target block that is the target to be decoded. Further, the target block may be the current block that is the target to be currently encoded and/or decoded. In other words, “target block” and “current block” may be used to have the same meaning and may be used interchangeably with each other.

Hereinafter, “block” and “unit” may be used to have the same meaning and may be used interchangeably with each other. Alternatively, “block” may denote a specific unit.

Hereinafter, “region” and “segment” may be used interchangeably with each other.

Hereinafter, a specific signal may be a signal indicating a specific block. For example, the original signal may be a signal indicating a target block. A prediction signal may be a signal indicating a prediction block. A residual signal may be a signal indicating a residual block.

In the following embodiments, specific information, data, a flag, an element, and an attribute may have their respective values. A value of 0 corresponding to each of the information, data, flag, element, and attribute may indicate a logical false or a first predefined value. In other words, a value of 0, false, logical false, and a first predefined value may be used interchangeably with each other. A value of “1” corresponding to each of the information, data, flag, element, and attribute may indicate a logical true or a second predefined value. In other words, a value of “1”, true, logical true, and a second predefined value may be used interchangeably with each other.

When a variable such as i or j is used to indicate a row, a column, or an index, the value of i may be an integer of 0 or more or an integer of 1 or more. In other words, in the embodiments, each of a row, a column, and an index may be counted from 0 or may be counted from 1.

Below, the terms to be used in embodiments will be described.

Unit: “unit” may denote the unit of image encoding and decoding. The meanings of the terms “unit” and “block” may be identical to each other. Further, the terms “unit” and “block” may be used interchangeably with each other.
“Unit” may be an M×N array of a sample. M and N may be positive integers, respectively. The term “unit” may generally mean a two-dimensional (2D) array of samples. The term “sample” may be either a pixel or a pixel value.
The term “pixel” and “sample” may be used to have the same meaning and may be used interchangeably with each other.
In the encoding and decoding of an image, “unit” may be an area generated by the partitioning of one image. A single image may be partitioned into multiple units. Upon encoding and decoding an image, processing predefined for each unit may be performed depending on the type of unit. Depending on the function, the types of unit may be classified into a macro unit, a Coding Unit (CU), a Prediction Unit (PU), and a Transform Unit (TU). A single unit may be further partitioned into lower units having a smaller size than that of the unit.
Unit partition information may include information about the depth of the unit. The depth information may indicate the number of times and/or the degree to which the unit is partitioned.
A single unit may be hierarchically partitioned into multiple lower units while having depth information based on a tree structure. In other words, the unit and lower units, generated by partitioning the unit, may correspond to a node and child nodes of the node, respectively. The individual partitioned lower units may have depth information. The depth information of the unit indicates the number of times and/or the degree to which the unit is partitioned, and thus the partition information of the lower units may include information about the sizes of the lower units.
In a tree structure, the top node may correspond to the initial node before partitioning. The top node may be referred to as a ‘root node’. Further, the root node may have a minimum depth value. Here, the top node may have a depth of level ‘0’.
A node having a depth of level ‘1’ may denote a unit generated when the initial unit is partitioned once. A node having a depth of level ‘2’ may denote a unit generated when the initial unit is partitioned twice.
A leaf node having a depth of level ‘n’ may denote a unit generated when the initial unit has been partitioned n times.
The leaf node may be a bottom node, which cannot be partitioned any further. The depth of the leaf node may be the maximum level. For example, a predefined value for the maximum level may be 3.
Transform Unit (TU): A TU may be the basic unit of residual signal encoding and/or residual signal decoding, such as transform, inverse transform, quantization, inverse quantization, transform coefficient encoding, and transform coefficient decoding. A single TU may be partitioned into multiple TUs, each having a smaller size.
Prediction Unit (PU): A PU may be a basic unit in the performance of prediction or compensation. The PU may be separated into multiple partitions via partitioning. The multiple partitions may also be basic units in the performance of prediction or compensation. The partitions generated via the partitioning of the PU may also be prediction units.
   Reconstructed neighbor unit: A reconstructed neighbor unit may be a unit that has been previously decoded and reconstructed near a target unit. The reconstructed neighbor unit may be either a unit spatially adjacent to the target unit or a unit temporally adjacent to the target unit.
   Prediction unit partition: A prediction unit partition may mean a shape in which the PU is partitioned.
   Parameter set: A parameter set may correspond to information about the header of the structure of a bitstream. For example, a parameter set may include a sequence parameter set, a picture parameter set, an adaptation parameter set, etc.
   Rate-distortion optimization: An encoding apparatus may use rate-distortion optimization so as to provide higher encoding efficiency by utilizing combinations of the size of a CU, a prediction mode, the size of a prediction unit, motion information, and the size of a TU.
   Rate-distortion optimization scheme: this scheme may calculate rate-distortion costs of respective combinations so as to select an optimal combination from among the combinations. The rate-distortion costs may be calculated using the following Equation 1. Generally, a combination enabling the rate-distortion cost to be minimized may be selected as the optimal combination in the rate-distortion optimization scheme.

D+λ*R [Equation 1]

Here, D may denote distortion. D may be the mean of squares of differences (mean square error) between original transform coefficients and reconstructed transform coefficients in a transform unit.

R denotes the rate, which may denote a bit rate using related context information.

λ denotes a Lagrangian multiplier. R may include not only encoding parameter information, such as a prediction mode, motion information, and a coded block flag, but also bits generated due to the encoding of transform coefficients.

The encoding apparatus may perform procedures such as inter-prediction and/or intra-prediction, transform, quantization, entropy coding, inverse quantization, and inverse transform so as to calculate precise D and R. These procedures may greatly increase the complexity of the encoding apparatus.
Reference picture: A reference picture may be an image used for inter-prediction or motion compensation. A reference picture may be a picture including a reference unit referred to by a target unit to perform inter-prediction or motion compensation.
Reference picture list: A reference picture list may be a list including reference pictures used for inter-prediction or motion compensation. The types of reference picture lists may be a List Combined (LC), list 0 (L0), list 1 (L1), etc.
Motion Vector (MV): A MV may be a 2D vector used for inter-prediction. For example, a MV may be represented in a form such as (mvₓ, mv_{y}). mvₓ may indicate a horizontal component and mv_{y} may indicate a vertical component.
MV may denote an offset between a target picture and a reference picture.
Search range: a search range may be a 2D area in which a search for a MV is performed during inter-prediction. For example, the size of the search range may be M×N. M and N may be positive integers, respectively.

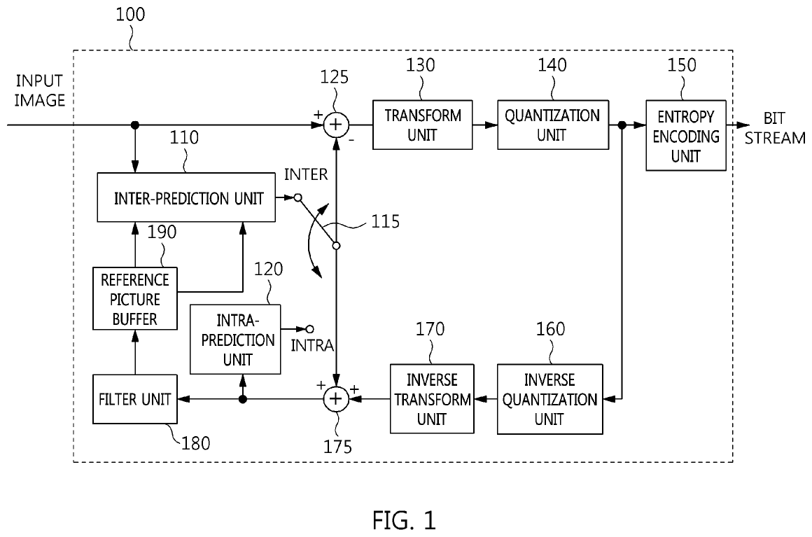

FIG. 1 is a block diagram illustrating the configuration of an embodiment of an encoding apparatus to which the present invention is applied.

An encoding apparatus 100 may be a video encoding apparatus or an image encoding apparatus. A video may include one or more images (pictures). The encoding apparatus 100 may sequentially encode one or more images of the video over time.

Referring to FIG. 1, the encoding apparatus 100 includes an inter-prediction unit 110, an intra-prediction unit 120, a switch 115, a subtractor 125, a transform unit 130, a quantization unit 140, an entropy decoding unit 150, an inverse quantization unit 160, an inverse transform unit 170, an adder 175, a filter unit 180, and a reference picture buffer 190.

The encoding apparatus 100 may perform encoding on a target image using an intra mode and an inter mode.

Further, the encoding apparatus 100 may generate a bitstream, including information about encoding, via encoding on the target image, and may output the generated bitstream.

When the intra mode is used, the switch 115 may switch to the intra mode. When the inter mode is used, the switch 115 may switch to the inter mode.

The encoding apparatus 100 may generate a prediction block for a target block. Further, after the prediction block has been generated, the encoding apparatus 100 may encode a residual between the target block and the prediction block.

When the prediction mode is an intra mode, the intra-prediction unit 120 may use pixels of previously encoded neighboring blocks around the target block as reference pixels. The intra-prediction unit 120 may perform spatial prediction on the target block using the reference pixels and generate prediction samples for the target block via spatial prediction.

The inter-prediction unit 110 may include a motion prediction unit and a motion compensation unit.

When the prediction mode is an inter mode, the motion prediction unit may search a reference image for an area most closely matching the target block in a motion prediction procedure, and may derive a motion vector for the target block and the found area. The reference image may be stored in the reference picture buffer 190. More specifically, the reference image may be stored in the reference picture buffer 190 when the encoding and/or decoding of the reference image have been processed.

The motion compensation unit may generate a prediction block for the target block by performing motion compensation using a motion vector. Here, the motion vector may be a two-dimensional (2D) vector used for inter-prediction. Further, the motion vector may indicate an offset between the target image and the reference image.

The subtractor 125 may generate a residual block which is the residual between the target block and the prediction block.

The transform unit 130 may generate a transform coefficient by transforming the residual block, and may output the generated transform coefficient. Here, the transform coefficient may be a coefficient value generated by transforming the residual block. When a transform skip mode is used, the transform unit 130 may omit transforming the residual block.

By applying quantization to the transform coefficient, a quantized transform coefficient level may be generated. Here, in the embodiments, the quantized transform coefficient level may also be referred to as a ‘transform coefficient’.

The quantization unit 140 may generate a quantized transform coefficient level by quantizing the transform coefficient depending on quantization parameters. The quantization unit 140 may output the quantized transform coefficient level. In this case, the quantization unit 140 may quantize the transform coefficient using a quantization matrix.

The entropy decoding unit 150 may generate a bitstream by performing probability distribution-based entropy encoding based on values, calculated by the quantization unit 140, and/or encoding parameter values, calculated in the encoding procedure. The entropy decoding unit 150 may output the generated bitstream.

The entropy decoding unit 150 may perform entropy encoding on information required to decode the image, in addition to the pixel information of the image. For example, the information required to decode the image may include syntax elements or the like.

The encoding parameters may be information required for encoding and/or decoding. The encoding parameters may include information encoded by the encoding apparatus 100 and transferred from the encoding apparatus 100 to a decoding apparatus, and may also include information that may be derived in the encoding or decoding procedure. For example, information transferred to the decoding apparatus may include syntax elements.

For example, the encoding parameters may include values or statistical information, such as a prediction mode, a motion vector, a reference picture index, an encoding block pattern, the presence or absence of a residual signal, a transform coefficient, a quantized transform coefficient, a quantization parameter, a block size, and block partition information. The prediction mode may be an intra-prediction mode or an inter-prediction mode.

The residual signal may denote the difference between the original signal and a prediction signal. Alternatively, the residual signal may be a signal generated by transforming the difference between the original signal and the prediction signal. Alternatively, the residual signal may be a signal generated by transforming and quantizing the difference between the original signal and the prediction signal.

When entropy encoding is applied, fewer bits may be assigned to more frequently occurring symbols, and more bits may be assigned to rarely occurring symbols. As symbols are represented by means of this assignment, the size of a bit string for target symbols to be encoded may be reduced. Therefore, the compression performance of video encoding may be improved through entropy encoding.

Further, for entropy encoding, a coding method such as exponential Golomb, Context-Adaptive Variable Length Coding (CAVLC), or Context-Adaptive Binary Arithmetic Coding (CABAC) may be used. For example, the entropy decoding unit 150 may perform entropy encoding using a Variable Length Coding/Code (VLC) table. For example, the entropy decoding unit 150 may derive a binarization method for a target symbol. Further, the entropy decoding unit 150 may derive a probability model for a target symbol/bin. The entropy decoding unit 150 may perform entropy encoding using the derived binarization method or probability model.

Since the encoding apparatus 100 performs encoding via inter prediction, the target image may be used as a reference image for additional image(s) to be subsequently processed. Therefore, the encoding apparatus 100 may decode the encoded target image and store the decoded image as a reference image in the reference picture buffer 190. For decoding, inverse quantization and inverse transform on the encoded target image may be processed.

The quantized coefficient may be inversely quantized by the inverse quantization unit 160, and may be inversely transformed by the inverse transform unit 170. The coefficient that has been inversely quantized and inversely transformed may be added to the prediction block by the adder 175. The inversely quantized and inversely transformed coefficient and the prediction block are added, and then a reconstructed block may be generated.

The reconstructed block may undergo filtering through the filter unit 180. The filter unit 180 may apply one or more of a deblocking filter, a Sample Adaptive Offset (SAO) filter, and an Adaptive Loop Filter (ALF) to the reconstructed block or a reconstructed picture. The filter unit 180 may also be referred to as an ‘adaptive in-loop filter’.

The deblocking filter may eliminate block distortion occurring at the boundaries of blocks. The SAO filter may add a suitable offset value to a pixel value so as to compensate for a coding error. The ALF may perform filtering based on the result of comparison between the reconstructed block and the original block. The reconstructed block subjected to filtering through the filter unit 180 may be stored in the reference picture buffer 190. The reconstructed block subjected to filtering through the filter unit 180 may be part of a reference picture. In other words, the reference picture may be a picture composed of reconstructed blocks subjected to filtering through the filter unit 180. The stored reference picture may be subsequently used for inter prediction.

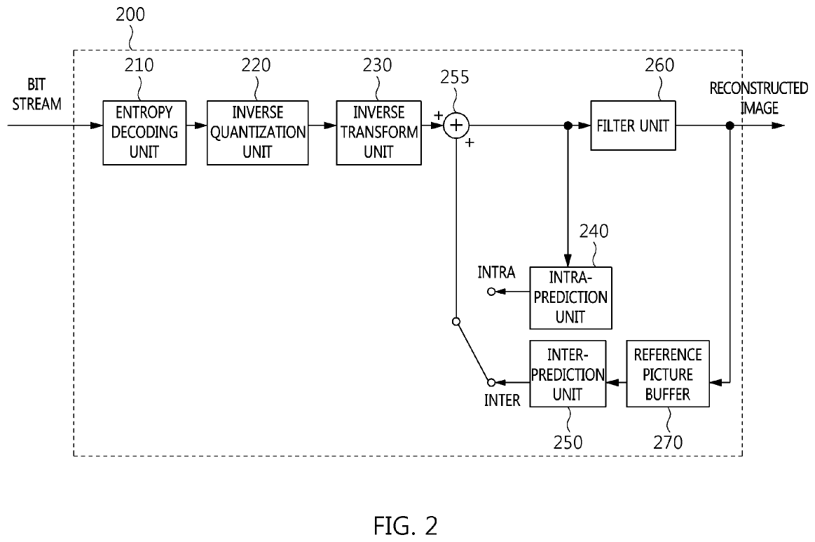

FIG. 2 is a block diagram illustrating the configuration of an embodiment of a decoding apparatus to which the present invention is applied.

A decoding apparatus 200 may be a video decoding apparatus or an image decoding apparatus.

Referring to FIG. 2, the decoding apparatus 200 may include an entropy decoding unit 210, an inverse quantization unit 220, an inverse transform unit 230, an intra-prediction unit 240, an inter-prediction unit 250, an adder 255, a filter unit 260, and a reference picture buffer 270.

The decoding apparatus 200 may receive a bitstream output from the encoding apparatus 100. The decoding apparatus 200 may perform decoding on the bitstream in an intra mode and/or an inter mode. Further, the decoding apparatus 200 may generate a reconstructed image via decoding and may output the reconstructed image.

For example, switching to an intra mode or an inter mode based on the prediction mode used for decoding may be performed by a switch. When the prediction mode used for decoding is an intra mode, the switch may be operated to switch to the intra mode. When the prediction mode used for decoding is an inter mode, the switch may be operated to switch to the inter mode.

The decoding apparatus 200 may acquire a reconstructed residual block from the input bitstream, and may generate a prediction block. When the reconstructed residual block and the prediction block are acquired, the decoding apparatus 200 may generate a reconstructed block by adding the reconstructed residual block to the prediction block.

The entropy decoding unit 210 may generate symbols by performing entropy decoding on the bitstream based on probability distribution. The generated symbols may include quantized coefficient-format symbols. Here, the entropy decoding method may be similar to the above-described entropy encoding method. That is, the entropy decoding method may be the reverse procedure of the above-described entropy encoding method.

The quantized coefficient may be inversely quantized by the inverse quantization unit 220. Further, the inversely quantized coefficient may be inversely transformed by the inverse transform unit 230. As a result of inversely quantizing and inversely transforming the quantized coefficient, a reconstructed residual block may be generated. Here, the inverse quantization unit 220 may apply a quantization matrix to the quantized coefficient.

When the intra mode is used, the intra-prediction unit 240 may generate a prediction block by performing spatial prediction that uses the pixel values of previously decoded neighboring blocks around a target block.

The inter-prediction unit 250 may include a motion compensation unit. When the inter mode is used, the motion compensation unit may generate a prediction block by performing motion compensation, which uses a motion vector and reference images. The reference images may be stored in the reference picture buffer 270.

The reconstructed residual block and the prediction block may be added to each other by the adder 255. The adder 255 may generate a reconstructed block by adding the reconstructed residual block to the prediction block.

The reconstructed block may be subjected to filtering through the filter unit 260. The filter unit 260 may apply one or more of a deblocking filter, an SAO filter, and an ALF to the reconstructed block or the reconstructed picture. The reconstructed block subjected to filtering through the filter unit 260 may be stored in the reference picture buffer 270. The reconstructed block subjected to filtering through the filter unit 280 may be part of a reference picture. The reconstructed block subjected to filtering through the filter unit 280 may be part of a reference picture. In other words, the reference picture may be a picture composed of reconstructed blocks subjected to filtering through the filter unit 280. The stored reference picture may be subsequently used for inter prediction.

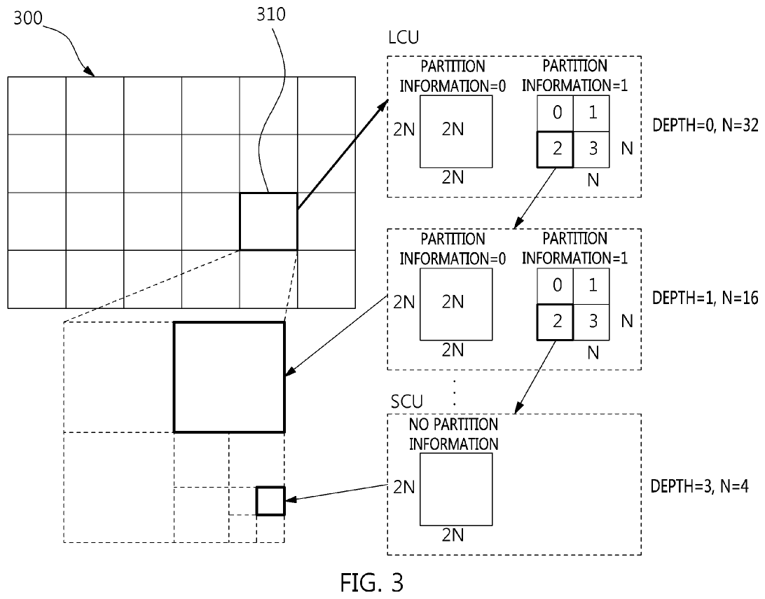

FIG. 3 is a diagram schematically illustrating an image partition structure when the image is encoded and decoded.

In order to efficiently partition the image, a Coding Unit (CU) may be used in encoding and decoding. The term “unit” may be used to collectively designate 1) a block including image samples and 2) a syntax element. For example, the “partitioning of a unit” may mean the “partitioning of a block corresponding to a unit”.

Referring to FIG. 3, an image 200 may be sequentially partitioned into units corresponding to a Largest Coding Unit (LCU), and the partition structure of the image 300 may be determined according to the LCU. Here, the LCU may be used to have the same meaning as a Coding Tree Unit (CTU).

The partition structure may mean the distribution of Coding Units (CUs) to efficiently encode the image in an LCU 310. Such a distribution may be determined depending on whether a single CU is to be partitioned into four CUs. The horizontal size and the vertical size of each of CUs generated from the partitioning may be half the horizontal size and the vertical size of a CU before being partitioned. Each partitioned CU may be recursively partitioned into four CUs, the horizontal size and the vertical size of which are halved in the same way.

Here, the partitioning of a CU may be recursively performed up to a predefined depth. Depth information may be information indicative of the size of a CU. Depth information may be stored for each CU. For example, the depth of an LCU may be 0, and the depth of a Smallest Coding Unit (SCU) may be a predefined maximum depth. Here, as described above, the LCU may be a CU having the maximum coding unit size, and the SCU may be a CU having the minimum coding unit size.

Partitioning may start at the LCU 310, and the depth of a CU may be increased by 1 whenever the horizontal and vertical sizes of the CU are halved by partitioning. For respective depths, a CU that is not partitioned may have a size of 2N×2N. Further, in the case of a CU that is partitioned, a CU having a size of 2N×2N may be partitioned into four CUs, each having a size of N×N. The size of N may be halved whenever the depth is increased by 1.

Referring to FIG. 3, an LCU having a depth of 0 may have 64×64 pixels. 0 may be a minimum depth. An SCU having a depth of 3 may have 8×8 pixels. 3 may be a maximum depth. Here, a CU having 64×64 pixels, which is the LCU, may be represented by a depth of 0. A CU having 32×32 pixels may be represented by a depth of 1. A CU having 16×16 pixels may be represented by a depth of 2. A CU having 8×8 pixels, which is the SCU, may be represented by a depth of 3.

Further, information about whether the corresponding CU is partitioned may be represented by the partition information of the CU. The partition information may be 1-bit information. All CUs except the SCU may include partition information. For example, when a CU is not partitioned, the value of the partition information of the CU may be 0. When a CU is partitioned, the value of the partition information of the CU may be 1.

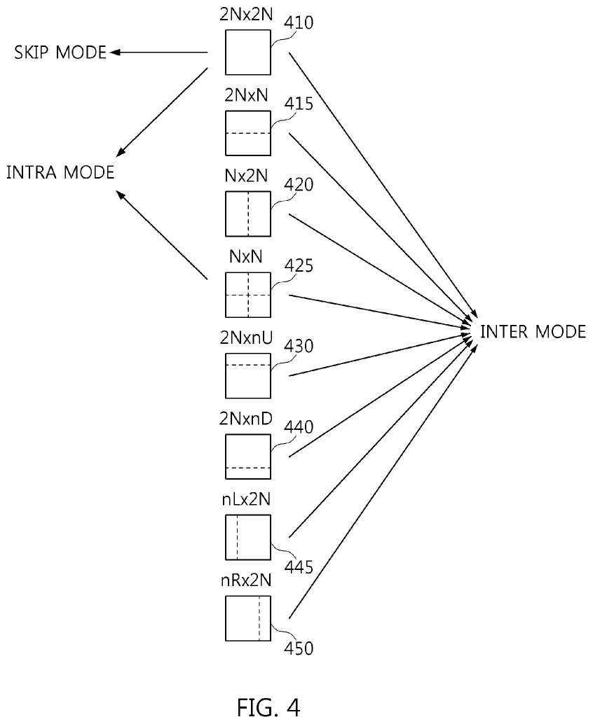

FIG. 4 is a diagram illustrating the form of a Prediction Unit (PU) that a Coding Unit (CU) can include.

When, among CUs partitioned from an LCU, a CU, which is not partitioned any further, may be divided into one or more Prediction Units (PUs). Such a division is also referred to as “partitioning”.

A PU may be a basic unit for prediction. A PU may be encoded and decoded in any one of a skip mode, an inter mode, and an intra mode. A PU may be partitioned into various shapes depending on respective modes. For example, the target block, described above with reference to FIG. 1, and the target block, described above with reference to FIG. 2, may each be a PU.

In a skip mode, partitioning may not be present in a CU. In the skip mode, a 2N×2N mode 410, in which the sizes of a PU and a CU are identical to each other, may be supported without partitioning.

In an inter mode, 8 types of partition shapes may be present in a CU. For example, in the inter mode, the 2N×2N mode 410, a 2N×N mode 415, an N×2N mode 420, an N×N mode 425, a 2N×nU mode 430, a 2N×nD mode 435, an nL×2N mode 440, and an nR×2N mode 445 may be supported.

In an intra mode, the 2N×2N mode 410 and the N×N mode 425 may be supported.

In the 2N×2N mode 410, a PU having a size of 2N×2N may be encoded. The PU having a size of 2N×2N may mean a PU having a size identical to that of the CU. For example, the PU having a size of 2N×2N may have a size of 64×64, 32×32, 16×16 or 8×8.

In the N×N mode 425, a PU having a size of N×N may be encoded.

For example, in intra prediction, when the size of a PU is 8×8, four partitioned PUs may be encoded. The size of each partitioned PU may be 4×4.

When a PU is encoded in an intra mode, the PU may be encoded using any one of multiple intra-prediction modes. For example, HEVC technology may provide 35 intra-prediction modes, and the PU may be encoded in any one of the 35 intra-prediction modes.

Which one of the 2N×2N mode 410 and the N×N mode 425 is to be used to encode the PU may be determined based on rate-distortion cost.

The encoding apparatus 100 may perform an encoding operation on a PU having a size of 2N×2N. Here, the encoding operation may be the operation of encoding the PU in each of multiple intra-prediction modes that can be used by the encoding apparatus 100. Through the encoding operation, the optimal intra-prediction mode for a PU having a size of 2N×2N may be derived. The optimal intra-prediction mode may be an intra-prediction mode in which a minimum rate-distortion cost occurs upon encoding the PU having a size of 2N×2N, among multiple intra-prediction modes that can be used by the encoding apparatus 100.

Further, the encoding apparatus 100 may sequentially perform an encoding operation on respective PUs obtained from N×N partitioning. Here, the encoding operation may be the operation of encoding a PU in each of multiple intra-prediction modes that can be used by the encoding apparatus 100. By means of the encoding operation, the optimal intra-prediction mode for the PU having an N×N size may be derived. The optimal intra-prediction mode may be an intra-prediction mode in which a minimum rate-distortion cost occurs upon encoding the PU having a size of N×N, among multiple intra-prediction modes that can be used by the encoding apparatus 100.

The encoding apparatus 100 may determine which one of the PU having a size of 2N×2N and PUs having a size of N×N is to be encoded based on the result of a comparison between the rate-distortion cost of the PU having a size of 2N×2N and the rate-distortion costs of PUs having a size of N×N.

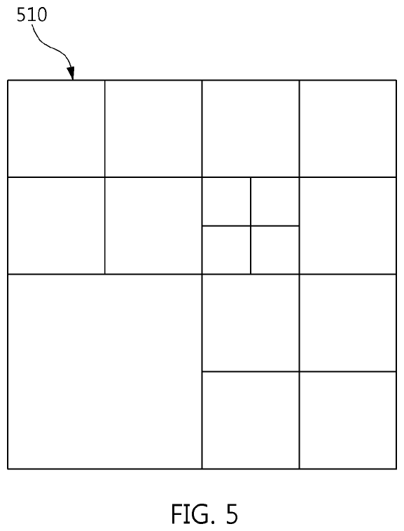

FIG. 5 is a diagram illustrating the form of a Transform Unit (TU) that can be included in a CU.

A Transform Unit (TU) may have a basic unit that is used for a procedure, such as transform, quantization, inverse transform, inverse quantization, entropy encoding, and entropy decoding, in a CU. A TU may have a square shape or a rectangular shape.

Among CUs partitioned from the LCU, a CU which is not partitioned into CUs any further may be partitioned into one or more TUs. Here, the partition structure of a TU may be a quad-tree structure. For example, as shown in FIG. 5, a single CU 510 may be partitioned one or more times depending on the quad-tree structure. By means of this partitioning, the single CU 510 may be composed of TUs having various sizes.

In the encoding apparatus 100, a Coding Tree Unit (CTU) having a size of 64×64 may be partitioned into multiple smaller CUs by a recursive quad-tree structure. A single CU may be partitioned into four CUs having the same size. Each CU may be recursively partitioned and may have a quad-tree structure.

A CU may have a given depth. When the CU is partitioned, CUs resulting from partitioning may have a depth increased from the depth of the partitioned CU by 1.

For example, the depth of a CU may have a value ranging from 0 to 3. The size of the CU may range from a size of 64×64 to a size of 8×8 depending on the depth of the CU.

By the recursive partitioning of a CU, an optimal partitioning method that incurs a minimum rate-distortion cost may be selected.

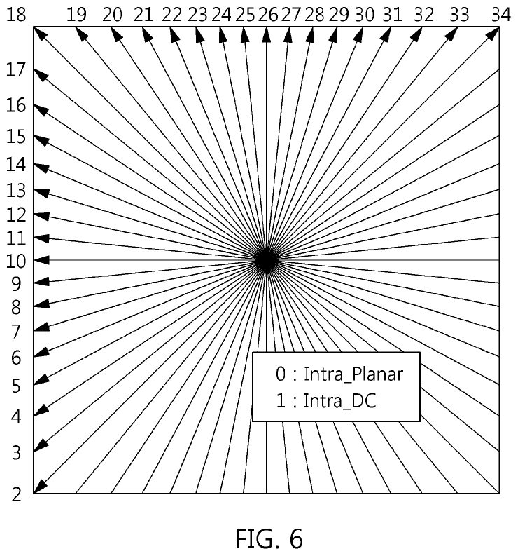

FIG. 6 is a diagram for explaining an embodiment of an intra-prediction process.

Arrows radially extending from the center of a graph in FIG. 6 may indicate the prediction directions of intra-prediction modes. Further, numbers indicated near the arrows may indicate examples of mode values assigned to intra-prediction modes or to the prediction directions of the intra-prediction modes.

Intra encoding and/or decoding may be performed using reference samples of blocks neighboring a target block. The neighboring blocks may be neighboring reconstructed blocks. For example, intra encoding and/or decoding may be performed using the values of reference samples which are included in each neighboring reconstructed block, or the encoding parameters of the neighboring reconstructed block.

The encoding apparatus 100 and/or the decoding apparatus 200 may generate a prediction block by performing intra prediction on a target block based on information about samples in a target image. When intra prediction is performed, the encoding apparatus 100 and/or the decoding apparatus 200 may generate a prediction block for the target block by performing intra prediction based on information about samples in the target image. When intra prediction is performed, the encoding apparatus 100 and/or the decoding apparatus 200 may perform directional prediction and/or non-directional prediction based on at least one reconstructed reference sample.

A prediction block may mean a block generated as a result of performing intra prediction. A prediction block may correspond to at least one of a CU, a PU, and a TU.

The unit of a prediction block may have a size corresponding to at least one of a CU, a PU, and a TU. The prediction block may have a square shape having a size of 2N×2N or N×N. The size of N×N may include a size of 4×4, 8×8, 16×16, 32×32, 64×64, or the like.

Alternatively, a prediction block may be either a square block having a size of 2×2, 4×4, 16×16, 32×32, 64×64, or the like, or a rectangular block having a size of 2×8, 4×8, 2×16, 4×16, 8×16, or the like.

Intra prediction may be performed depending on an intra-prediction mode for the target block. The number of intra-prediction modes which the target block can have may be a predefined fixed value, and may be a value determined differently depending on the attributes of a prediction block. For example, the attributes of the prediction block may include the size of the prediction block, the type of prediction block, etc.

For example, the number of intra-prediction modes may be fixed at 35 regardless of the size of a prediction block. Alternatively, the number of intra-prediction modes may be, for example, 3, 5, 9, 17, 34, 35, or 36.

The intra-prediction modes may include two non-directional modes and 33 directional modes, as shown in FIG. 6. The two non-directional modes may include a DC mode and a planar mode.

For example, in a vertical mode having a mode value of 26, prediction may be performed in a vertical direction based on the pixel value of a reference sample. For example, in a horizontal mode having a mode value of 10, prediction may be performed in a horizontal direction based on the pixel value of a reference sample.

Even in the directional modes other than the above-described mode, the encoding apparatus 100 and the decoding apparatus 200 may perform intra prediction on a target unit using reference samples depending on angles corresponding to the directional modes.

Intra-prediction modes located on a right side with respect to the vertical mode may be referred to as ‘vertical-right modes’. Intra-prediction modes located below the horizontal mode may be referred to as ‘horizontal-below modes’. For example, in FIG. 6, the intra-prediction modes in which a mode value is one of 27, 28, 29, 30, 31, 32, 33, and 34 may be vertical-right modes 613. Intra-prediction modes in which a mode value is one of 2, 3, 4, 5, 6, 7, 8, and 9 may be horizontal-below modes 616.

The non-directional modes may include a DC mode and a planar mode. For example, the mode value of the DC mode may be 1. The mode value of the planar mode may be 0.

The directional modes may include an angular mode. Among multiple intra-prediction modes, modes other than the DC mode and the planar mode may be the directional modes.

In the DC mode, a prediction block may be generated based on the average of pixel values of multiple reference samples. For example, the pixel value of the prediction block may be determined based on the average of pixel values of multiple reference samples.

The number of above-described intra-prediction modes and the mode values of respective intra-prediction modes are merely exemplary. The number of above-described intra-prediction modes and the mode values of respective intra-prediction modes may be defined differently depending on embodiments, implementation and/or requirements.

The number of intra-prediction modes may differ depending on the type of color component. For example, the number of prediction modes may differ depending on whether a color component is a luminance (luma) signal or a chrominance (chroma) signal.

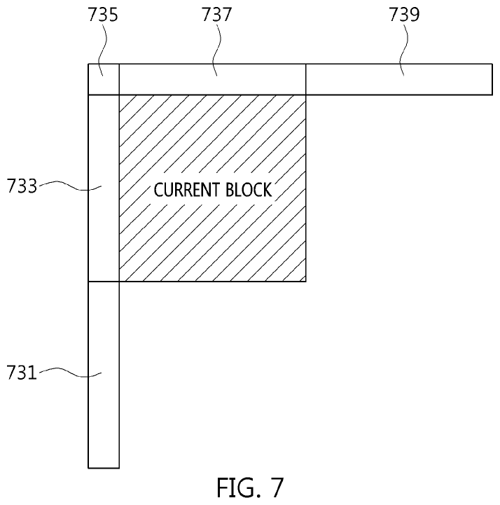

FIG. 7 is a diagram for explaining the locations of reference samples used in an intra-prediction procedure.

FIG. 7 illustrates the locations of reference samples used for intra prediction of a target block. Referring to FIG. 7, reconstructed reference pixels used for intra prediction of the target block may include, for example, below-left reference samples 731, left reference samples 733, an above-left corner reference sample 735, above reference samples 737, and above-right reference samples 739.

For example, the left reference samples 733 may mean reconstructed reference pixels adjacent to the left side of the target block. The above reference samples 737 may mean reconstructed reference pixels adjacent to the top of the target block. The above-left corner reference pixel 735 may mean a reconstructed reference pixel located at the above-left corner of the target block. The below-left reference samples 731 may mean reference samples located below a left sample line composed of the left reference samples 733, among samples located on the same line as the left sample line. The above-right reference samples 739 may mean reference samples located to the right of an above sample line composed of the above reference samples 737, among samples located on the same line as the above sample line.

When the size of a target block is N×N, the numbers of the below-left reference samples 731, the left reference samples 733, the above reference samples 737, and the above-right reference samples 739 may each be N.

By performing intra prediction on the target block, a prediction block may be generated. The generation of the prediction block may include the determination of the values of pixels in the prediction block. The sizes of the target block and the prediction block may be equal.

The reference samples used for intra prediction of the target block may vary depending on the intra-prediction mode of the target block. The direction of the intra-prediction mode may represent a dependence relationship between the reference samples and the pixels of the prediction block. For example, the value of a specified reference sample may be used as the values of one or more specified pixels in the prediction block. In this case, the specified reference sample and the one or more specified pixels in the prediction block may be the sample and pixels which are positioned in a straight line in the direction of an intra-prediction mode. In other words, the value of the specified reference sample may be copied as the value of a pixel located in a direction reverse to the direction of the intra-prediction mode. Alternatively, the value of a pixel in the prediction block may be the value of a reference sample located in the direction of the intra-prediction mode with respect to the location of the pixel.

In an example, when the intra-prediction mode of a target block is a vertical mode having a mode value of 26, the above reference samples 737 may be used for intra prediction. When the intra-prediction mode is the vertical mode, the value of a pixel in the prediction block may be the value of a reference pixel vertically located above the location of the pixel. Therefore, the above reference samples 737 adjacent to the top of the target block may be used for intra prediction. Furthermore, the values of pixels in one row of the prediction block may be identical to those of the above reference samples 737.

In an example, when the intra-prediction mode of the current block is a horizontal mode having a mode value of 10, the left reference samples 733 may be used for intra prediction. When the intra-prediction mode is the horizontal mode, the value of a pixel in the prediction block may be the value of a reference pixel horizontally located to the left of the pixel. Therefore, the left reference samples 733 adjacent to the left of the target block may be used for intra prediction. Further, the values of pixels in one column of the prediction block may be identical to those of the left reference samples 733.

In an example, when the mode value of the intra-prediction mode of the current block is 18, at least some of the left reference samples 733, the above-left corner reference sample 735, and at least some of the above reference samples 737 may be used for intra prediction. When the mode value of the intra-prediction mode is 18, the value of a pixel in the prediction block may be the value of a reference pixel diagonally located at the above-left corner of the pixel.

Further, when an intra-prediction mode having a mode value corresponding to 27, 28, 29, 30, 31, 32, 33 or 34 is used, at least some of the above-right reference pixels 739 may be used for intra prediction.

Furthermore, when an intra-prediction mode having a mode value corresponding to 2, 3, 4, 5, 6, 7, 8 or 9 is used, at least some of the below-left reference pixels 739 may be used for intra prediction.

In addition, when an intra-prediction mode having a mode value corresponding to any one of 11 to 25 is used, the above-left corner reference sample 735 may be used for intra prediction.

The number of reference samples used to determine the pixel value of one pixel in the prediction block may be either 1, or 2 or more.

As described above, the pixel value of a pixel in the prediction block may be determined depending on the location of the pixel and the location of a reference sample indicated by the direction of the intra-prediction mode. When the location of the pixel and the location of the reference sample indicated by the direction of the intra-prediction mode are integer positions, the value of one reference sample indicated by an integer position may be used to determine the pixel value of the pixel in the prediction block.

When the location of the pixel and the location of the reference sample indicated by the direction of the intra-prediction mode are not integer positions, an interpolated reference sample based on two reference samples closest to the location of the reference sample may be generated. The value of the interpolated reference sample may be used to determine the pixel value of the pixel in the prediction block. In other words, when the location of the pixel in the prediction block and the location of the reference sample indicated by the direction of the intra-prediction mode indicate the location between two reference samples, an interpolated value based on the values of the two samples may be generated.

The prediction block generated via prediction may not be identical to an original target block. In other words, there may be a prediction error which is the difference between the target block and the prediction block, and there may also be a prediction error between the pixel of the target block and the pixel of the prediction block. For example, in the case of directional intra prediction, the longer the distance between the pixel of the prediction block and the reference sample, the greater the prediction error that may occur. Such a prediction error may result in discontinuity between the generated prediction block and neighboring blocks.

In order to reduce the prediction error, filtering for the prediction block may be used. Filtering may be configured to adaptively apply a filter to an area, regarded as having a large prediction error, in the prediction block. For example, the area regarded as having a large prediction error may be the boundary of the prediction block. Further, an area regarded as having a large prediction error in the prediction block may differ depending on the intra-prediction mode, and the characteristics of filters may also differ depending thereon.

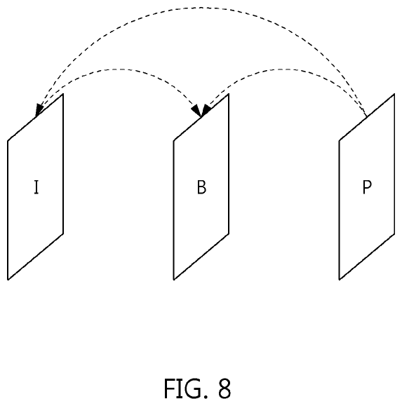

FIG. 8 is a diagram for explaining an embodiment of an inter prediction procedure.

The rectangles shown in FIG. 8 may represent images (or pictures). Further, in FIG. 8, arrows may represent prediction directions. That is, each image may be encoded and/or decoded depending on the prediction direction.

Images may be classified into an Intra Picture (I picture), a Uni-prediction Picture or Predictive Coded Picture (P picture), and a Bi-prediction Picture or Bi-predictive Coded Picture (B picture) depending on the encoding type. Each picture may be encoded depending on the encoding type thereof.

When a target image that is the target to be encoded is an I picture, the target image may be encoded using data contained in the image itself without inter prediction that refers to other images. For example, an I picture may be encoded only via intra prediction.

When a target image is a P picture, the target image may be encoded via inter prediction that uses reference pictures only in a forward direction.

When a target image is a B picture, the image may be encoded via inter prediction that uses reference pictures both in a forward direction and in a backward direction, or may be encoded via inter prediction that uses reference pictures in one of the forward direction and the backward direction.

A P picture and a B picture that are encoded and/or decoded using reference pictures may be regarded as images in which inter prediction is used.

Below, inter prediction in an inter mode according to an embodiment will be described in detail.

In an inter mode, the encoding apparatus 100 and the decoding apparatus 200 may perform prediction and/or motion compensation on a target block.

For example, the encoding apparatus 100 or the decoding apparatus 200 may perform prediction and/or motion compensation by using motion information of a spatial candidate and/or a temporal candidate as motion information of the target block. The target block may mean a PU and/or a PU partition.

A spatial candidate may be a reconstructed block which is spatially adjacent to the target block.

A temporal candidate may be a reconstructed block corresponding to the target block in a previously reconstructed collocated picture (col picture).

In inter prediction, the encoding apparatus 100 and the decoding apparatus 200 may improve encoding efficiency and decoding efficiency by utilizing the motion information of a spatial candidate and/or a temporal candidate. The motion information of a spatial candidate may be referred to as ‘spatial motion information’. The motion information of a temporal candidate may be referred to as ‘temporal motion information’.

Below, the motion information of a spatial candidate may be the motion information of a PU including the spatial candidate. The motion of a temporal candidate may be the motion information of a PU including the temporal candidate. The motion information of a candidate block may be the motion information of a PU including the candidate block.

Inter prediction may be performed using a reference picture.

The reference picture may be at least one of a picture previous to a target picture and a picture subsequent to the target picture. The reference picture may be an image used for the prediction of the target block.

In inter prediction, a region in the reference picture may be specified by utilizing a reference picture index (or refIdx) for indicating a reference picture, a motion vector, which will be described later, etc. Here, the region specified in the reference picture may indicate a reference block.

Inter prediction may select a reference picture, and may also select a reference block corresponding to the target block from the reference picture. Further, inter prediction may generate a prediction block for the target block using the selected reference block.

The motion information may be derived during inter prediction by each of the encoding apparatus 100 and the decoding apparatus 200.

A spatial candidate may be a block 1) which is present in a target picture, 2) which has been previously reconstructed via encoding and/or decoding, and 3) which is adjacent to the target block or is located at the corner of the target block. Here, the “block located at the corner of the target block” may be either a block vertically adjacent to a neighboring block that is horizontally adjacent to the target block, or a block horizontally adjacent to a neighboring block that is vertically adjacent to the target block. Further, the “block located at the corner of the target block” may have the same meaning as a “block adjacent to the corner of the target block”. The “block located at the corner of the target block” may be included in the “block adjacent to the target block”.

For example, a spatial candidate may be a reconstructed block located to the left of the target block, a reconstructed block located above the target block, a reconstructed block located at the below-left corner of the target block, a reconstructed block located at the above-right corner of the target block, or a reconstructed block located at the above-left corner of the target block.

Each of the encoding apparatus 100 and the decoding apparatus 200 may identify a block present at the location spatially corresponding to the target block in a col picture. The location of the target block in the target picture and the location of the identified block in the col picture may correspond to each other.

Each of the encoding apparatus 100 and the decoding apparatus 200 may determine a col block present at the predefined relative location for the identified block to be a temporal candidate. The predefined relative location may be either a location present inside and/or outside the identified block.

For example, the col block may include a first col block and a second col block. When the coordinates of the identified block are (xP, yP) and the size of the identified block is represented by (nPSW, nPSH), the first col block may be a block located at coordinates (xP+nPSW, yP+nPSH). The second col block may be a block located at coordinates (xP+(nPSW>>1), yP+(nPSH>>1)). The second col block may be selectively used when the first col block is unavailable.

The motion vector of the target block may be determined based on the motion vector of the col block. Each of the encoding apparatus 100 and the decoding apparatus 200 may scale the motion vector of the col block. The scaled motion vector of the col block may be used as the motion vector of the target block. Further, a motion vector for the motion information of a temporal candidate stored in a list may be a scaled motion vector.

The ratio of the motion vector of the target block to the motion vector of the col block may be identical to the ratio of a first distance to a second distance. The first distance may be the distance between the reference picture and the target picture of the target block. The second distance may be the distance between the reference picture and the col picture of the col block.

A scheme for deriving motion information may change depending on the inter-prediction mode of a target block. For example, as inter-prediction modes applied for inter prediction, an Advanced Motion Vector Predictor (AMVP) mode, a merge mode, a skip mode, etc. may be present. Individual modes will be described in detail below.

1) AMVP Mode

When an AMVP mode is used, the encoding apparatus 100 may search a neighboring region of a target block for a similar block. The encoding apparatus 100 may acquire a prediction block by performing prediction on the target block using motion information of the found similar block. The encoding apparatus 100 may encode a residual block that is the difference between the target block and the prediction block.

1-1) Generation of List of Predictive Motion Vector Candidates

When an AMVP mode is used as the prediction mode, each of the encoding apparatus 100 and the decoding apparatus 200 may create a list of predictive motion vector candidates using the motion vectors of spatial candidates and/or the motion vectors of temporal candidates. The motion vectors of spatial candidates and/or the motion vectors of temporal candidates may be used as predictive motion vector candidates.

The predictive motion vector candidates may be motion vector predictors for predicting a motion vector. Also, in the encoding apparatus 100, each predictive motion vector candidate may be an initial search location for a motion vector.

1-2) Search for Motion Vectors that Use List of Predictive Motion Vector Candidates

The encoding apparatus 100 may determine a motion vector to be used to encode a target block within a search range using a list of predictive motion vector candidates. Further, the encoding apparatus 100 may determine a predictive motion vector candidate to be used as the predictive motion vector of the target block, among predictive motion vector candidates present in the predictive motion vector candidate list.

The motion vector to be used to encode the target block may be a motion vector that can be encoded at minimum cost.

Further, the encoding apparatus 100 may determine whether to use the AMVP mode to encode the target block.

1-3) Transmission of Inter-Prediction Information

The encoding apparatus 100 may generate a bitstream including inter-prediction information required for inter prediction. The decoding apparatus 100 may perform inter prediction on the target block using the inter-prediction information of the bitstream.

The inter-prediction information may contain 1) mode information indicating whether an AMVP mode is used, 2) a predictive motion vector index, 3) a Motion Vector Difference (MVD), 4) a reference direction, and 5) a reference picture index.

Further, the inter-prediction information may contain a residual signal.

The decoding apparatus 200 may acquire a predictive motion vector index, an MVD, a reference direction, and a reference picture index from the bitstream only when mode information indicates that the AMVP mode is used.

The predictive motion vector index may indicate a predictive motion vector candidate to be used for the prediction of a target block, among predictive motion vector candidates included in the predictive motion vector candidate list.

1-4) Inter Prediction in AMVP Mode that Uses Inter-Prediction Information

The decoding apparatus 200 may select a predictive motion vector candidate, indicated by the predictive motion vector index, from among predictive motion vector candidates included in the predictive motion vector candidate list, as the predictive motion vector of the target block.

The motion vector to be actually used for inter prediction of the target block may not match the predictive motion vector. In order to indicate the difference between the motion vector to be actually used for inter prediction of the target block and the predictive motion vector, an MVD may be used. The encoding apparatus 100 may derive a predictive motion vector similar to the motion vector to be actually used for inter prediction of the target block so as to use an MVD that is as small as possible.

An MVD may be the difference between the motion vector of the target block and the predictive motion vector. The encoding apparatus 100 may calculate an MVD and may encode the MVD.

The MVD may be transmitted from the encoding apparatus 100 to the decoding apparatus 200 through a bitstream. The decoding apparatus 200 may decode the received MVD. The decoding apparatus 200 may derive the motion vector of the target block using the sum of the decoded MVD and the predictive motion vector.

The reference direction may indicate a list of reference pictures to be used for prediction of the target block. For example, the reference direction may indicate one of a reference picture list L0 and a reference picture list L1.

The reference direction merely indicates the reference picture list to be used for prediction of the target block, and may not mean that the directions of reference pictures are limited to a forward direction or a backward direction. In other words, each of the reference picture list L0 and the reference picture list L1 may include pictures in a forward direction and/or a backward direction.

The reference direction being unidirectional may mean that a single reference picture list is used. The reference direction being bidirectional may mean that two reference picture lists are used. In other words, the reference direction may indicate one of the case where only the reference picture list L0 is used, the case where only the reference picture list L1 is used, and the case where two reference picture lists are used.

The reference picture index may indicate a reference picture to be used for prediction of a target block, among reference pictures in the reference picture list.

When two reference picture lists are used to predict the target block, a single reference picture index and a single motion vector may be used for each of the reference picture lists. Further, when two reference picture lists are used to predict the target block, two prediction blocks may be specified for the target block. For example, the (final) prediction block of the target block may be generated using the average or weighted-sum of the two prediction blocks for the target block.

The motion vector of the target block may be specified by the predictive motion vector index, the MVD, the prediction direction, and the reference picture index.

The decoding apparatus 200 may generate a prediction block for the target block based on the derived motion vector and reference picture index information. For example, the prediction block may be a reference block, indicated by the derived motion vector, in the reference picture indicated by the reference picture index information.

Since the predictive motion vector index and the MVD are encoded without the motion vector itself of the target block being encoded, the number of bits transmitted from the encoding apparatus 100 to the decoding apparatus 200 may be decreased, and the encoding efficiency may be improved.

For the target block, the motion information of reconstructed neighboring blocks may be used. In a specific inter-prediction mode, the encoding apparatus 100 may not separately encode the actual motion information of the target block. The motion information of the target block is not encoded, and additional information that enables the motion information of the target block to be derived using the motion information of reconstructed neighboring blocks may be encoded instead. As the additional information is encoded, the number of bits transmitted to the decoding apparatus 200 may be decreased, and encoding efficiency may be improved.

For example, as inter-prediction modes in which the motion information of the target block is not directly encoded, there may be a skip mode and/or a merge mode. Here, each of the encoding apparatus 100 and the decoding apparatus 200 may use an identifier and/or an index that indicates a unit, the motion information of which is to be used as the motion information of the target unit, among reconstructed neighboring units.

2) Merge Mode

As a scheme for deriving the motion information of a target block, there is merging. The term “merging” may mean the merging of the motion of multiple blocks. “Merging” may mean that the motion information of one block is also applied to other blocks.

When a merge mode is used, the encoding apparatus 100 may predict the motion information of a target block using the motion information of a spatial candidate and/or the motion information of a temporal candidate. The encoding apparatus 100 may acquire a prediction block via prediction. The encoding apparatus 100 may encode a residual block that is the difference between the target block and the prediction block.

2-1) Generation of Merge Candidate List

When the merge mode is used, each of the encoding apparatus 100 and the decoding apparatus 200 may generate a merge candidate list using the motion information of a spatial candidate and/or the motion information of a temporal candidate. The motion information may include 1) a motion vector, 2) a reference picture index, and 3) a reference direction. The reference direction may be unidirectional or bidirectional.

The merge candidate list may include merge candidates. The merge candidates may be motion information. In other words, the merge candidates may be pieces of motion information of temporal candidates and/or spatial candidates. Further, the merge candidate list may include new merge candidates generated by a combination of merge candidates that are already present in the merge candidate list. Furthermore, the merge candidate list may include motion information of a zero vector.

Each merge candidate may include 1) a motion vector, 2) a reference picture index, and 3) a reference direction.

The merge candidate list may be generated before prediction in the merge mode is performed.

The number of merge candidates in the merge candidate list may be predefined. Each of the encoding apparatus 100 and the decoding apparatus 200 may add merge candidates to the merge candidate list depending on the predefined scheme and predefined priorities so that the merge candidate list has a predefined number of merge candidates. The merge candidate list of the encoding apparatus 100 and the merge candidate list of the decoding apparatus 200 may be made identical to each other using the predefined scheme and the predefined priorities.

Merging may be applied on a CU basis or a PU basis. When merging is performed on a CU basis or a PU basis, the encoding apparatus 100 may transmit a bitstream including predefined information to the decoding apparatus 200. For example, the predefined information may contain 1) information indicating whether to perform merging for individual block partitions, and 2) information about a block with which merging is to be performed, among blocks that are spatial candidates and/or temporal candidates for the target block.

2-2) Search for Motion Vector that Uses Merge Candidate List

The encoding apparatus 100 may determine merge candidates to be used to encode a target block. For example, the encoding apparatus 100 may perform prediction on the target block using merge candidates in the merge candidate list and may generate residual blocks for the merge candidates. The encoding apparatus 100 may use a merge candidate that incurs a minimum cost in prediction and in the encoding of residual blocks to encode the target block.

Further, the encoding apparatus 100 may determine whether to use a merge mode to encode the target block.

2-3) Transmission of Inter-Prediction Information

The encoding apparatus 100 may generate a bitstream that includes inter-prediction information required for inter prediction. The decoding apparatus 200 may perform inter prediction on the target block using the inter-prediction information of the bitstream.

The inter-prediction information may contain 1) mode information indicating whether a merge mode is used and 2) a merge index.

Further, the inter-prediction information may contain a residual signal.

The decoding apparatus 200 may acquire the merge index from the bitstream only when the mode information indicates that the merge mode is used.

The merge index may indicate a merge candidate to be used for the prediction of the target block, among merge candidates included in the merge candidate list.

2-4) Inter Prediction of Merge Mode that Uses Inter-Prediction Information

The decoding apparatus 200 may perform prediction on the target block using the merge candidate indicated by the merge index, among merge candidates included in the merge candidate list.

The motion vector of the target block may be specified by the motion vector, reference picture index, and reference direction of the merge candidate indicated by the merge index.

3) Skip Mode

A skip mode may be a mode in which the motion information of a spatial candidate or the motion information of a temporal candidate is applied to the target block without change. Also, the skip mode may be a mode in which a residual signal is not used. In other words, when the skip mode is used, a reconstructed block may be a prediction block.

The difference between the merge mode and the skip mode is whether to transmit or use a residual signal. That is, the skip mode may be similar to the merge mode except that a residual signal is not transmitted or used.

When the skip mode is used, the encoding apparatus 100 may transmit only information about a block, the motion information of which is to be used as the motion information of the target block, among blocks that are spatial candidates or temporal candidates, to the decoding apparatus 200 through a bitstream. Further, when the skip mode is used, the encoding apparatus 100 may not transmit other syntax information, such as an MVD, to the decoding apparatus 200.

3-1) Generation of Merge Candidate List

The skip mode may also use a merge candidate list. In other words, a merge candidate list may be used both in the merge mode and in the skip mode. In this aspect, the merge candidate list may also be referred to as a “skip candidate list” or a “merge/skip candidate list”.

Alternatively, the skip mode may use an additional candidate list different from that of the merge mode. In this case, in the following description, a merge candidate list and a merge candidate may be replaced by a skip candidate list and a skip candidate, respectively.

The merge candidate list may be generated before prediction in the skip mode is performed.

3-2) Search for Motion Vector that Uses Merge Candidate List

The encoding apparatus 100 may determine the merge candidates to be used to encode a target block. For example, the encoding apparatus 100 may perform prediction on the target block using the merge candidates in a merge candidate list. The encoding apparatus 100 may use a merge candidate that incurs the minimum cost in prediction to encode the target block.

Further, the encoding apparatus 100 may determine whether to use a skip mode to encode the target block.

3-3) Transmission of Inter-Prediction Information

The encoding apparatus 100 may generate a bitstream that includes inter-prediction information required for inter prediction. The decoding apparatus 200 may perform inter prediction on the target block using the inter-prediction information of the bitstream.

The inter-prediction information may include 1) mode information indicating whether a skip mode is used, and 2) a skip index.

The skip index may be identical to the above-described merge index.

When the skip mode is used, the target block may be encoded without using a residual signal. The inter-prediction information may not contain a residual signal. Alternatively, the bitstream may not include a residual signal.

The decoding apparatus 200 may acquire a skip index from the bitstream only when the mode information indicates that the skip mode is used. As described above, a merge index and a skip index may be identical to each other. The decoding apparatus 200 may acquire the skip index from the bitstream only when the mode information indicates that the merge mode or the skip mode is used.

The skip index may indicate a merge candidate to be used for the prediction of the target block among the merge candidates included in the merge candidate list.

3-4) Inter Prediction in Skip Mode that Uses Inter-Prediction Information

The decoding apparatus 200 may perform prediction on the target block using a merge candidate indicated by a skip index, among the merge candidates included in a merge candidate list.

The motion vector of the target block may be specified by the motion vector, reference picture index, and reference direction of the merge candidate indicated by the skip index.

In the above-described AMVP mode, merge mode, and skip mode, motion information to be used for the prediction of a target block may be specified, among pieces of motion information in the list, using the index of the list.

In order to improve encoding efficiency, the encoding apparatus 100 may signal only the index of an element that incurs the minimum cost in inter prediction of the target block, among elements in the list. The encoding apparatus 100 may encode the index and may signal the encoded index.

Therefore, the above-described lists (i.e. the predictive motion vector candidate list and the merge candidate list) must be able to be derived by the encoding apparatus 100 and the decoding apparatus 200 using the same scheme based on the same data. Here, the same data may include a reconstructed picture and a reconstructed block. Further, in order to specify an element using an index, the sequence of elements in the list must be fixed.

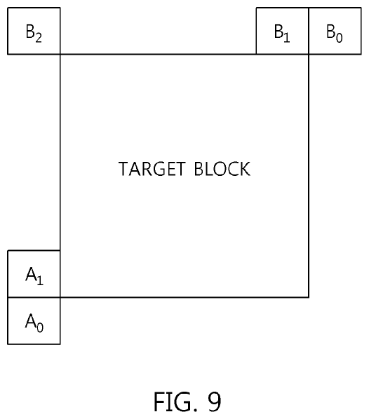

FIG. 9 illustrates spatial candidates according to an embodiment.

In FIG. 9, the locations of spatial candidates are illustrated.

A large block at the center of the drawing may denote a target block. Five small blocks may denote spatial candidates.

The coordinates of the target block may be (xP, yP), and the size of the target block may be represented by (nPSW, nPSH).

Spatial candidate A₀ may be a block adjacent to the below-left corner of the target block. A₀ may be a block that occupies pixels located at coordinates (xP−1, yP+nPSH+1).

Spatial candidate A₁ may be a block adjacent to the left of the target block. A₁ may be a lowermost block, among blocks adjacent to the left of the target block. Alternatively, A₁ may be a block adjacent to the top of A₀. A₁ may be a block that occupies pixels located at coordinates (xP−1, yP+nPSH).

Spatial candidate B₀ may be a block adjacent to the above-right corner of the target block. B₀ may be a block that occupies pixels located at coordinates (xP+nPSW+1, yP−1).

Spatial candidate B₁ may be a block adjacent to the top of the target block. B₁ may be a rightmost block, among blocks adjacent to the top of the target block. Alternatively, B₁ may be a block adjacent to the left of B₀. B₁ may be a block that occupies pixels located at coordinates (xP+nPSW, yP−1).

Spatial candidate B₂ may be a block adjacent to the above-left corner of the target block. B₂ may be a block that occupies pixels located at coordinates (xP−1, yP−1).

Determination of Availability of Spatial Candidate and Temporal Candidate

In order to include the motion information of a spatial candidate or the motion information of a temporal candidate in a list, it must be determined whether the motion information of the spatial candidate or the motion information of the temporal candidate is available.

Hereinafter, a candidate block may include a spatial candidate and a temporal candidate.

For example, the determination may be performed by sequentially applying the following steps 1) to 4).

Step 1)

When a PU including a candidate block is out of the boundary of a picture, the availability of the candidate block may be set to “false”. “Availability is set to false” may have the same meaning as “set to be unavailable”.

Step 2)

When a PU including a candidate block is out of the boundary of a slice, the availability of the candidate block may be set to “false”. When the target block and the candidate block are located in different slices, the availability of the candidate block may be set to “false”.

Step 3)

When a PU including a candidate block is out of the boundary of a tile, the availability of the candidate block may be set to “false”. When the target block and the candidate block are located in different tiles, the availability of the candidate block may be set to “false”.

Step 4)

When the prediction mode of a PU including a candidate block is an intra-prediction mode, the availability of the candidate block may be set to “false”. When a PU including a candidate block does not use inter prediction, the availability of the candidate block may be set to “false”.

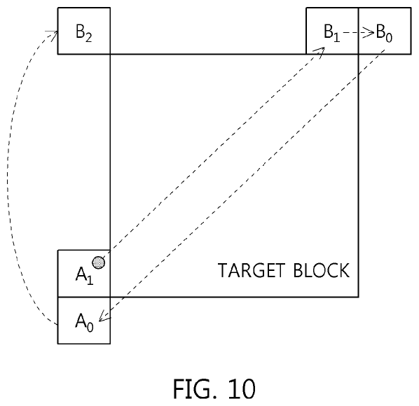

FIG. 10 illustrates the sequence of addition of motion information of spatial candidates to a merge list according to an embodiment.

As shown in FIG. 10, when pieces of motion information of spatial candidates are added to a merge list, the sequence of A₁, B₁, B₀, A₀, and B₂ may be used. That is, pieces of motion information of available spatial candidates may be added to the merge list in the sequence of A₁, B₁, B₀, A₀, and B₂.

Method for Deriving Merge List in Merge Mode and Skip Mode

As described above, the maximum number of merge candidates in the merge list may be set. The set maximum number is indicated by “N”. The set number may be transmitted from the encoding apparatus 100 to the decoding apparatus 200. The slice header of a slice may include N. In other words, the maximum number of merge candidates in the merge list for the target block of the slice may be set by the slice header. For example, the value of N may be basically 5.

Pieces of motion information (i.e., merge candidates) may be added to the merge list in the sequence of the following steps 1) to 4).

Step 1)

Among spatial candidates, available spatial candidates may be added to the merge list. Pieces of motion information of the available spatial candidates may be added to the merge list in the sequence illustrated in FIG. 10. Here, when the motion information of an available spatial candidate overlaps other motion information already present in the merge list, the motion information may not be added to the merge list. The operation of checking whether the corresponding motion information overlaps other motion information present in the list may be referred to in brief as an “overlap check”.

The maximum number of pieces of motion information that are added may be N.

Step 2)

When the number of pieces of motion information in the merge list is less than N and a temporal candidate is available, the motion information of the temporal candidate may be added to the merge list. Here, when the motion information of the available temporal candidate overlaps other motion information already present in the merge list, the motion information may not be added to the merge list.

Step 3)

When the number of pieces of motion information in the merge list is less than N and the type of a target slice is “B”, combined motion information generated by combined bidirectional prediction (bi-prediction) may be added to the merge list.

The target slice may be a slice including a target block.

The combined motion information may be a combination of L0 motion information and L1 motion information. L0 motion information may be motion information that refers only to a reference picture list L0. L1 motion information may be motion information that refers only to a reference picture list L1.

In the merge list, one or more pieces of L0 motion information may be present. Further, in the merge list, one or more pieces of L1 motion information may be present.

The combined motion information may include one or more pieces of combined motion information. When the combined motion information is generated, L0 motion information and L1 motion information that are to be used for generation, among the one or more pieces of L0 motion information and the one or more pieces of L1 motion information, may be predefined. One or more pieces of combined motion information may be generated in a predefined sequence via combined bidirectional prediction that uses a pair of different pieces of motion information in the merge list. One of the pair of different pieces of motion information may be L0 motion information and the other of the pair may be L1 motion information.

For example, combined motion information that is added with the highest priority may be a combination of L0 motion information having a merge index of 0 and L1 motion information having a merge index of 1. When motion information having a merge index of 0 is not L0 motion information or when motion information having a merge index of 1 is not L1 motion information, the combined motion information may be neither generated nor added. Next, the combined motion information that is added with the next priority may be a combination of L0 motion information having a merge index of 1 and L1 motion information having a merge index of 0. Subsequent detailed combinations may conform to other combinations of video encoding/decoding fields.

Here, when the combined motion information overlaps other motion information already present in the merge list, the combined motion information may not be added to the merge list.

Step 4)

When the number of pieces of motion information in the merge list is less than N, motion information of a zero vector may be added to the merge list.

The zero-vector motion information may be motion information for which the motion vector is a zero vector.

The number of pieces of zero-vector motion information may be one or more. The reference picture indices of one or more pieces of zero-vector motion information may be different from each other. For example, the value of the reference picture index of first zero-vector motion information may be 0. The value of the reference picture index of second zero-vector motion information may be 1.

The number of pieces of zero-vector motion information may be identical to the number of reference pictures in the reference picture list.

The reference direction of zero-vector motion information may be bidirectional. Both the motion vectors may be zero vectors. The number of pieces of zero-vector motion information may be the smaller one of the number of reference pictures in the reference picture list L0 and the number of reference pictures in the reference picture list L1. Alternatively, when the number of reference pictures in the reference picture list L0 and the number of reference pictures in the reference picture list L1 are different from each other, a reference direction that is unidirectional may be used for a reference picture index that may be applied only to a single reference picture list.

The encoding apparatus 100 and/or the decoding apparatus 200 may sequentially add the zero-vector motion information to the merge list while changing the reference picture index.

When zero-vector motion information overlaps other motion information already present in the merge list, the zero-vector motion information may not be added to the merge list.

The sequence of the above-described steps 1) to 4) is merely exemplary and may be changed. Further, some of the above steps may be omitted depending on predefined conditions.

Method for Deriving Predictive Motion Vector Candidate List in AMVP Mode

The maximum number of predictive motion vector candidates in a predictive motion vector candidate list may be predefined. The predefined maximum number is indicated by N. For example, the predefined maximum number may be 2.

Pieces of motion information (i.e. predictive motion vector candidates) may be added to the predictive motion vector candidate list in the sequence of the following steps 1) to 3).

Step 1)

Available spatial candidates, among spatial candidates, may be added to the predictive motion vector candidate list. The spatial candidates may include a first spatial candidate and a second spatial candidate.

The first spatial candidate may be one of A₀, A₁, scaled A₀, and scaled A₁. The second spatial candidate may be one of B₀, B₁, B₂, scaled B₀, scaled B₁, and scaled B₂.

Pieces of motion information of available spatial candidates may be added to the predictive motion vector candidate list in the sequence of the first spatial candidate and the second spatial candidate. In this case, when the motion information of an available spatial candidate overlaps other motion information already present in the predictive motion vector candidate list, the motion information may not be added to the predictive motion vector candidate list. In other words, when the value of N is 2, if the motion information of a second spatial candidate is identical to the motion information of a first spatial candidate, the motion information of the second spatial candidate may not be added to the predictive motion vector candidate list.

The maximum number of pieces of motion information that are added may be N.

Step 2)

When the number of pieces of motion information in the predictive motion vector candidate list is less than N and a temporal candidate is available, the motion information of the temporal candidate may be added to the predictive motion vector candidate list. In this case, when the motion information of the available temporal candidate overlaps other motion information already present in the predictive motion vector candidate list, the motion information may not be added to the predictive motion vector candidate list.

Step 3)

When the number of pieces of motion information in the predictive motion vector candidate list is less than N, zero motion information may be added to the predictive motion vector candidate list.

The zero motion information may include one or more pieces of zero motion information. The reference picture indices of the one or more pieces of zero motion information may be different from each other.

The encoding apparatus 100 and/or the decoding apparatus 200 may sequentially add pieces of zero motion information to the predictive motion vector candidate list while changing the reference picture index.

When zero motion information overlaps other motion information already present in the predictive motion vector candidate list, the zero motion information may not be added to the predictive motion vector candidate list.

A description of the zero-vector motion information, described above in relation to the merge list, may also be applied to zero motion information. A repeated description thereof will be omitted.

The sequence of the above-described steps 1) to 3) is merely exemplary, and may be changed. Further, some of the steps may be omitted depending on predefined conditions.

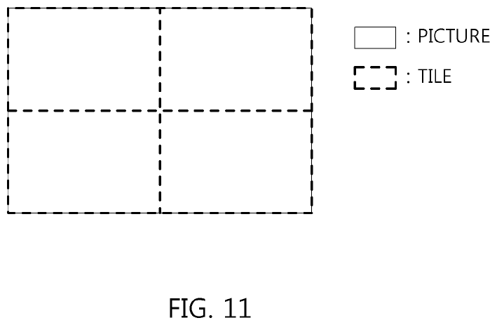

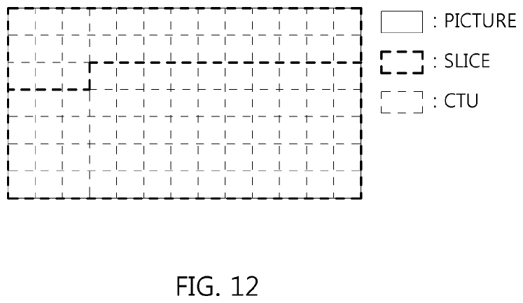

FIG. 11 illustrates the partitioning of a picture that uses tiles according to an embodiment.

In FIG. 11, a picture is indicated by a solid line, and tiles are indicated by dotted lines. The picture may be partitioned into multiple tiles.

Each tile may be one of entities used as the partition units of a picture. A tile may be the partition unit of a picture. Alternatively, a tile may be the unit of picture partitioning encoding.

Information about tiles may be signaled through a Picture Parameter Set (PPS). A PPS may contain information about tiles of a picture or information required in order to partition a picture into multiple tiles.

The following Table 1 shows an example of the structure of pic_parameter_set_rbsp. The picture partition information may be pic_parameter_set_rbsp or may include pic_parameter_set_rbsp.

TABLE 1

| pic_parameter_set_rbsp( ) { | Descriptor |
|---|---|
| . . . | |
| tiles_enabled_flag | u(1) |
| if( tiles_enabled_flag ) { | |
| num_tile_columns_minus1 | ue(v) |
| num_tile_rows_minus1 | ue(v) |
| uniform_spacing_flag | u(1) |
| if( !uniform_spacing_flag ) { | |
| for( i = 0; i < num_tile_columns_minus1; i++ ) | |
| column_width_minus1[ i ] | ue(v) |
| for(i = 0; i < num_tile_rows_minus1; i++) | |
| row_height_minus1[ i ] | ue(v) |
| } | |
| } | |
| . . . | |
| } | |

“pic_parameter_set_rbsp” may include the following elements.
tiles_enabled_flag: “tiles_enabled_flag” may be a tile presence indication flag that indicates whether one or more tiles are present in a picture that refers to the PPS.

For example, a tiles_enabled_flag value of “0” may represent that no tiles are present in the picture that refers to the PPS. A tiles_enabled_flag value of “1” may represent that one or more tiles are present in the picture that refers to the PPS.

The values of the tile presence indication flags tiles_enabled_flag of all activated PPSs in a single Coded Video Sequence (CVS) may be identical to each other.
num_tile_columns_minus1: “num_tile_columns_minus1” may be information about the number of column tiles corresponding to the number of tiles arranged in the lateral direction of a partitioned picture. For example, the value of “num_tile_columns_minus1+1” may denote the number of lateral tiles in the partitioned picture. Alternatively, the value of “num_tile_columns_minus1+1” may denote the number of tiles in one row.
num_tile_rows_minus1: “num_tile_rows_minus1” may be information about the number of row tiles corresponding to the number of tiles arranged in the longitudinal direction of the partitioned picture. For example, the value of “num_tile_rows_minus1+1” may denote the number of longitudinal tiles in the partitioned picture. Alternatively, “num_tile_row_minus1+1” may denote the number of tiles in one column.
uniform_spacing_flag: “uniform_spacing_flag” may be a uniform spacing indication flag that indicates whether a picture is equally partitioned into tiles in a lateral direction and a longitudinal direction. For example, uniform_spacing_flag may be a flag indicating whether the sizes of tiles in the picture are equal to each other. For example, a uniform_spacing_flag value of “0” may represent that the picture is not equally partitioned in the lateral direction and/or the longitudinal direction. A uniform_spacing_flag value of “1” may represent that the picture is equally partitioned in the lateral direction and the longitudinal direction. When the value of uniform_spacing_flag is “0”, elements that define in greater detail partitioning, such as column_width_minus1[i] and row_height_minus1[i], which will be described later, may be additionally required in order to partition the picture.
column_width_minus1[i]: “column_width_minus1[i]” may be tile width information corresponding to the width of a tile in an i-th column. Here, i may be an integer that is equal to or greater than 0 and is less than the number n of columns of tiles. For example, “column_width_minus1[i]+1” may denote the width of a tile in an i+l-th column. The width may be represented by a predefined unit. For example, the unit of width may be a Coding Tree Block (CTB).
row_height_minus1[i]: “row_height_minus1[i]” may be tile height information corresponding to the height of a tile in an i-th row. Here, i may be an integer that is equal to or greater than 0 and that is less than the number n of rows of tiles. For example, “row_height_minus1[i]+1” may denote the height of a tile in an i+1-th row. The height may be represented by a predefined unit. For example, the unit of height may be a Coding Tree Block (CTB).

In an example, picture partition information may be included in the PPS, and may be transmitted as a part of the PPS when the PPS is transmitted. The decoding apparatus may acquire picture partition information required in order to partition the picture by referring to the PPS of the picture.

In order to signal picture partition information differing from information that has been previously transmitted, the encoding apparatus may transmit a new PPS, which includes new picture partition information and a new PPS ID, to the decoding apparatus. Then, the encoding apparatus may transmit a slice header containing the PPS ID to the decoding apparatus.

FIG. 11 illustrates the partitioning of a picture that uses slices according to an embodiment.

In FIG. 11, a picture is indicated by a solid line, slices are indicated by bold dotted lines, and Coding Tree Units (CPUs) are indicated by thin dotted lines. As shown in the drawing, the picture may be partitioned into multiple slices. One slice may be composed of one or more consecutive CTUs.

A slice may be one of entities that are used as the partition units of a picture. A slice may be the partition unit of the picture. Alternatively, a slice may be the unit of picture partitioning encoding.

Information about the slice may be signaled through a slice segment header. The slice segment header may contain information about slices.

When the slice is the unit of picture partitioning encoding, the picture partition information may define the start address of each of one or more slices.

The unit of the start address of each slice may be a CTU. The picture partition information may define the start CTU address of each of one or more slices. The partition shape of a picture may be defined by the start addresses of the slices.

The following Table 2 shows an example of the structure of slice_segment_header. The picture partition information may be slice_segment_header or may include slice_segment_header.

TABLE 2

| slice_segment_header ( ) { | Descriptor |
|---|---|
| . . . | |
| first_slice_segment_in_pic_flag | u(1) |
| if( !first_slice_segment_in_pic_flag) { | |
| if( dependent_slice_segments_enabled_flag) | |
| dependent_slice_segment_flag | u(1) |
| slice_segment_address | u(v) |
| } | |
| . . . | |
| } | |

“slice_segment_header” may include the following elements.
first_slice_segment_in_pic_flag: “first_slice_segment_in_pic_flag” may be a first slice indication flag that indicates whether a slice indicated by slice_segment_header is a first slice in a picture.

For example, a first_slice_segment_in_pic_flag value of “0” may represent that the corresponding slice is not the first slice in the picture. A first_slice_segment_in_pic_flag value of “1” may represent that the corresponding slice is the first slice in the picture.
dependent_slice_segment_flag: “dependent_slice_segment_flag” may be a dependent slice segment indication flag that indicates whether the slice indicated by slice_segment_header is a dependent slice.

For example, a dependent_slice_segment_flag value of “0” may represent that the corresponding slice is not a dependent slice. A dependent_slice_segment_flag value of “1” may represent that the corresponding slice is a dependent slice.

For example, a substream slice for Wavefront Parallel Processing; (WPP) may be a dependent slice. There may be an independent slice corresponding to the dependent slice. When a slice indicated by slice_segment_header is a dependent slice, at least one element of slice_segment_header may not be present. In other words, the values of elements in slice_segment_header may not be defined. For elements for which values in a dependent slice are not defined, the values of elements of an independent slice corresponding to the dependent slice may be used. In other words, the value of a specific element that is not present in the slice_segment_header of a dependent slice may be identical to the value of a specific element in the slice_segment_header of the independent slice corresponding to the dependent slice. For example, the dependent slice may inherit the values of elements in the independent slice corresponding thereto, and may redefine the values of at least some elements in the independent slice.
slice_segment_address: “slice_segment_address” may be start address information indicating the start address of a slice indicated by slice_segment_header. The unit of the start address information may be a CTB.

The methods for partitioning a picture into one or more slices may include the following methods 1) to 3).

Method 1):

The first method may be a method for partitioning a picture by the maximum size of a bitstream that one slice can include.

Method 2):

The second method may be a method for partitioning a picture by the maximum number of CTUs that one slice can include.

Method 3):

The third method may be a method for partitioning a picture by the maximum number of tiles that one slice can include.

When the encoding apparatus intends to perform parallel encoding on a slice basis, the second method and the third method, among the three methods, may be typically used.

In the case of the first method, the size of a bitstream may be known after encoding has been completed, and thus it may be difficult to define slices to be processed in parallel before encoding starts. Therefore, the picture partitioning method that enables slice-based parallel encoding may be the second method, which uses the unit of the maximum number of CTUs, and the third method, which uses the unit of the maximum number of tiles.

When the second method and the third method are used, the partition size of the picture may be predefined before the picture is encoded in parallel. Further, depending on the defined size, slice_segment_address may be calculated. When the encoding apparatus uses a slice as the unit of parallel encoding, there is typically a tendency for slice_segment_address to be repeated at regular periods and/or depending on specific rules without changing for each picture.

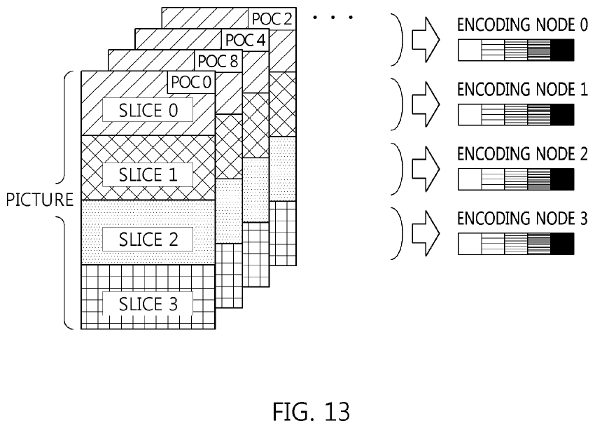

FIG. 13 illustrates distributed encoding of a temporally-spatially partitioned picture according to an embodiment.

In FIG. 13, a configuration in which one picture is partitioned into four slices is illustrated. Further, each of the four pictures is partitioned into four slices. Each picture may include slice 0, slice 1, slice 2 and slice 3.

In other words, a video may be temporally and spatially partitioned. Each picture of the video may be partitioned into a specific number of slices.

The slices of each picture may be processed by an encoding node.

The same slices of pictures may be bound in units of an intra period. The slices of the pictures may be encoded in parallel by multiple encoding nodes distributed over a network.

For example, as shown in FIG. 13, respective slices 0 of pictures may be processed by encoding node 0, respective slices 1 of the pictures may be processed by encoding node 1, respective slices 2 of the pictures may be processed by encoding node 2, and respective slices 3 of pictures may be processed by encoding node 3.

In parallel encoding, inter reference is not allowed between blocks in different slices, and thus the efficiency of communication and parallel encoding between nodes may be improved.

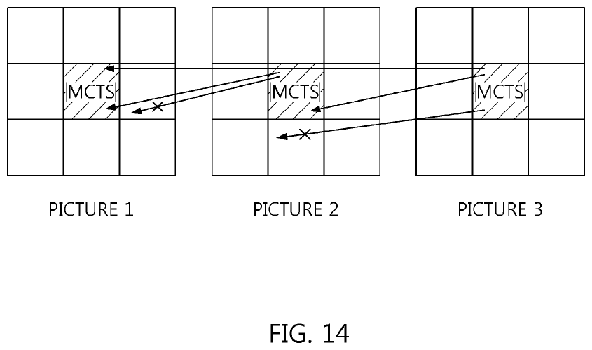

FIG. 14 illustrates the processing of a Motion-Constrained Tile Set (MCTS) according to an embodiment.

MCTS may be a set of one or more tiles that limits the range of inter prediction is to a specific region in a picture.

For example, when a Region of Interest (ROI) in the picture is set to an MCTS, a region of the picture, which is out of the boundary of the MCTS, may not be used for inter prediction.

In FIG. 14, inter prediction for picture 2 is shown as using only the region of MCTS in picture 1. Further, inter prediction for picture 3 is shown as using only the region of MCTS in picture 1 and the region of MCTS in picture 2.

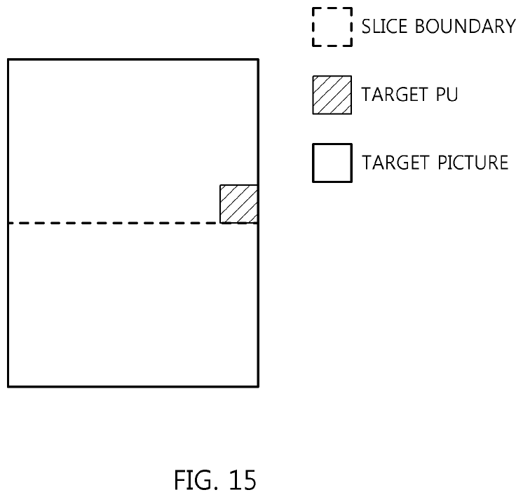

FIG. 15 illustrates a PU adjacent to the boundary of a slice according to an embodiment.

In FIG. 15, a target picture is illustrated. The target picture is partitioned into two slices. In the target picture, a slice boundary between two slices is present.

Further, a target PU that is a target block is adjacent to a slice boundary and a picture boundary.

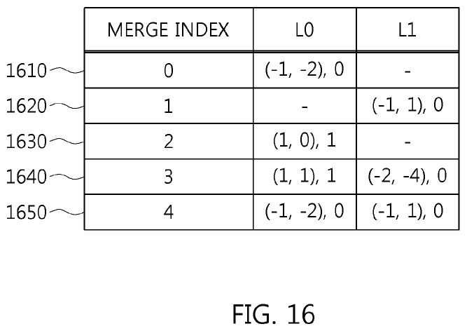

When the above-described scheme for adding the motion information of a spatial candidate to a list is used to generate the list, there may frequently occur the case where the motion information in the list cannot be used as the motion information of the target PU. This case will be described in detail below with reference to FIG. 16.

FIG. 16 illustrates a merge list according to an embodiment.

The merge list of FIG. 16 may be a merge list generated for the target PU of FIG. 15.

The merge list of FIG. 16 may be generated using the above-described merge list generation method.

The maximum number of pieces of motion information in the merge list may be 5.

Each row in the merge list may indicate motion information. For example, a first row 1610 may indicate motion information for which the value of a merge index is 0.

A first column in the merge list may indicate a merge index. A second column and a third column may indicate reference picture lists for motion information. For the motion information that uses a reference picture list L0, a motion vector and a reference picture index may be described in the second column. For the motion information that uses a reference picture list L1, a motion vector and a reference picture index may be described in the third column. For pieces of motion information that use the reference picture list L0 and the reference picture list L1, respectively, respective motion vectors and respective reference picture indices may be described in the second column and the third column.

The expression “(X, Y), Z” may indicate a motion vector (X, Y) and a reference picture index Z.

For example, “(−1, −2), 0” and “−” in the first row 1610 may represent that first motion information is information corresponding to motion vector (−1, −2), the reference picture list L0, and reference picture index 0, and that the reference picture list L1 is not used. The motion information in the first row 1610 may indicate a reference picture having an index of 0, among reference pictures in the reference picture list L0, and may indicate a motion vector which moves to the left by one column and moves upwards by two rows.

Further, a fourth row 1640 may denote motion information of bidirectional prediction, which indicates the reference picture list L0 and the reference picture list L1.

Since the target PU of FIG. 15 is located in a below-right portion of a slice, the location indicated by a motion vector applied to a target PU may be out of the boundary of a picture or the boundary of the slice if one of an x value and a y value in the motion vector of the motion information is equal to or greater than 1. Therefore, such motion information cannot be used for a target PU unless an additional control method such as control based on the use of an MVD is used.

For example, motion information in a second row 1620 may result from spatial candidate B₁. For B₁, a motion vector (−1, 1) may be a valid motion vector that is not out of a slice boundary and a picture boundary. However, the motion vector (−1, 1) may be a motion vector that is out of the slice boundary for the target PU. That is, the motion vector (−1, 1) may be a motion vector that cannot be used for the target PU, and the motion information in the second column may be motion information that cannot be used.

For example, a motion vector (1, 0) in a third row 1630 may result from spatial candidate B₂. However, the motion vector (1, 0) may be a motion vector that is out of a picture boundary for the target PU.

For example, a motion vector (1, 1) in the fourth row 1640 may result from a temporal candidate. However, the motion vector (1, 1) may be a motion vector that is out of a picture boundary for the target PU.

For example, motion information in a fifth row 1650 may be combined motion information generated by combined bi-prediction of the motion information in the first row 1610 and the motion information in the second row 1620. However, since the motion information in the second row 1602 cannot be used for the target PU, the motion information in the fifth row 1650 cannot be generated either.

As described above, in some cases, a large number of pieces of motion information in the merge list may not be used for the target block. Further, such unusable motion information may prevent other subordinated motion information from being added to the merge list.

In this case, the encoding apparatus 100 cannot use motion information that causes a determined location to be out of the slice boundary or the picture boundary, among pieces of motion information in the merge list. In specific cases, none of the pieces of motion information in the merge list may actually be used.

When the encoding apparatus 100 selects an optimal inter-prediction mode for the target block, encoding efficiency may be deteriorated because the use of at least some of the pieces of motion information in the merge list is limited. Further, certain motion information may cause overhead such as MVD.

In the following embodiments, a motion prediction boundary check method for improving encoding efficiency while limiting the range of inter prediction is presented.

The process for the motion prediction boundary check may be performed when it is desired to add the motion information of a candidate block to the list or determine the availability of the candidate block.

The motion prediction boundary check may be configured to check whether the location determined using the motion information of a candidate block is out of a region or a boundary. In other words, the motion prediction boundary check may be configured to check whether the location referred to by the target block based on the motion vector of the motion information is present within the corresponding region. In other words, in inter prediction, the location referred to by the target block may be limited to the inside of the region. Motion information having passed the motion prediction boundary check may be used for the motion prediction of the target block.

The term “determined location” may be the location indicated by the motion vector of the motion information applied to the target block. Here, the location indicated by the motion vector may be the location where the motion vector is added to the location of the target block.

Based on the motion prediction boundary check, the motion information of the candidate block may be added as a motion information candidate for the target block to the list only when the determined location is present within the region (or when the determined location is not out of the boundary).

The region may be a region of a slice including the target block, a region of a tile including the target block, or a region of an MCTS including the target block. In other words, the region may be a unit including the target block, among the partition units of the picture.

The boundary may include the boundary of a picture. Further, the boundary may include the boundary between slices, the boundary between tiles, or the boundary between MCTSs. In other words, the boundary may denote 1) the boundary of a picture and 2) the boundary between a unit, including the target block, and another unit, among the partition units of the picture.

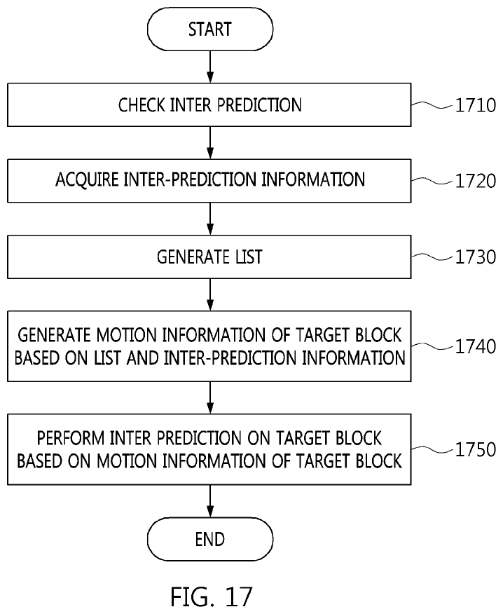

FIG. 17 is a flowchart of an inter prediction method according to an embodiment.

At step 1710, the inter-prediction unit 250 may check that inter prediction is used for prediction of a target block.

For example, when the prediction information of a bitstream indicates inter prediction, the inter-prediction unit 250 may check that inter prediction is used for the target block.

At step 1720, the inter-prediction unit 250 may acquire inter-prediction information from the bitstream.

The inter-prediction information may contain mode information. The mode information may indicate which one of 1) an AMVP mode, 2) a merge mode, and 3) a skip mode is used for inter prediction of the target block.

The mode information may include multiple pieces of mode information. For example, the inter-prediction information may contain skip mode information. The skip mode information may indicate that a skip mode is used for inter prediction of the target block.

The inter-prediction information may differ according to the mode information.

At step 1730, the inter-prediction unit 250 may generate a list.

The list may be a predictive motion vector candidate list or a merge list.

The list may be a list corresponding to the mode indicated by the inter-prediction information. For example, when the inter-prediction information indicates that an AMVP mode is used, the generated list may be a predictive motion vector candidate list. When the inter-prediction information indicates that a merge mode or a skip mode is used, the generated list may be a merge list.

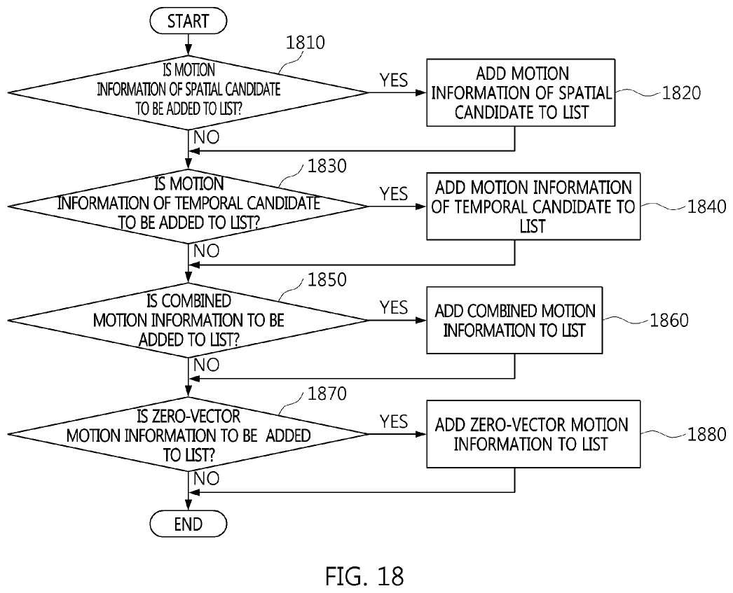

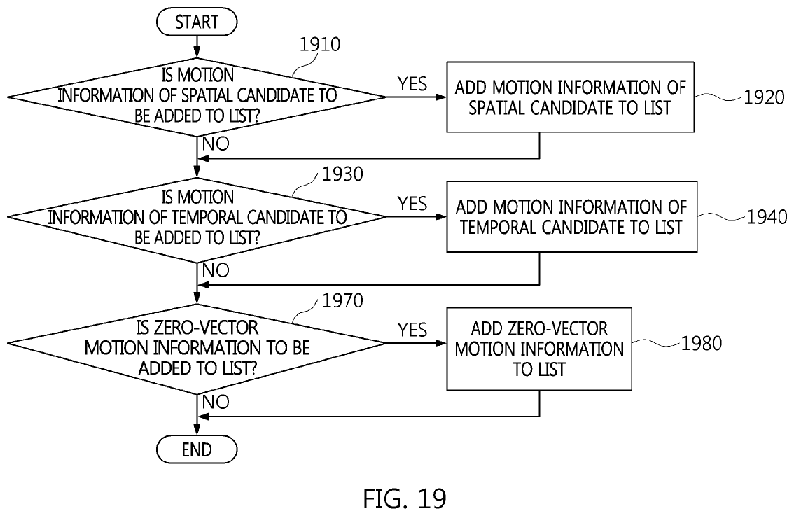

The generation of the lists will be described in greater detail later with reference to FIGS. 18 and 19.

At step 1740, the inter-prediction unit 250 may generate motion information of the target block based on the list and the inter-prediction information.

At step 1750, the inter-prediction unit 250 may perform inter prediction on the target block based on the motion information of the target block.

At least some of steps 1710, 1720, 1730, 1740, and 1750 may also be performed by the inter-prediction unit 110 of the encoding apparatus 100. For example, step 1730 of generating the list may also be performed by the encoding apparatus 100 in the same manner. In the following descriptions related to steps, the inter-prediction unit 250 may be replaced by the inter-prediction unit 110.

Steps 1710, 1720, 1730, 1740, and 1750 may be combined with the operations of other components of the encoding apparatus 100, described above with reference to FIG. 1. Further, steps 1710, 1720, 1730, 1740, and 1750 may be combined with the operations of other components of the decoding apparatus 200, described above with reference to FIG. 2.

FIG. 18 is a flowchart of a method for generating a merge list for inter prediction of a target block according to an embodiment.

Step 1730, described above with reference to FIG. 17, may include steps 1810, 1820, 1830, 1840, 1850, 1860, 1870 and 1880, which will be described below.

In the present embodiment, an intra-prediction mode for a target block may be either a merge mode or a skip mode. The list may be a merge list. The motion information of a candidate block may correspond to a merge candidate.

At step 1810, the inter-prediction unit 230 may determine whether the motion information of a spatial candidate is to be added to the list.

If it is determined that the motion information of the spatial candidate is to be added to the list, step 1820 may be performed.

If it is determined that the motion information of the spatial candidate is not to be added to the list, step 1830 may be performed.

At step 1820, if it is determined that the motion information of the spatial candidate is to be added to the list, the inter-prediction unit 230 may add the motion information of the spatial candidate to the list.

At steps 1810 and 1820, the motion information of the spatial candidate may be added to the list.

In an embodiment, at steps 1810 and 1820, the inter-prediction unit 230 may determine whether the motion information of the spatial candidate is to be added to the list, based on information about the target block and the motion information of the spatial candidate.

In an embodiment, the information about the target block may be the location of the target block. The inter-prediction unit 230 may determine whether the motion information of the spatial candidate is to be added to the list, based on the location of the target block and the motion vector of the spatial candidate.

In an embodiment, the inter-prediction unit 230 may determine whether the motion information of the spatial candidate is to be added to the list, based on the target block and a motion prediction boundary check for the spatial candidate.

In an embodiment, the inter-prediction unit 230 may determine whether the motion information of the spatial candidate is to be added to the list, based on a location indicated by a motion vector applied to the target block. Here, the applied motion vector may be the motion vector of the motion information of the spatial candidate.

Here, the location indicated by the motion vector may be a location determined by adding the motion vector to the location of the target block.

Further, the location indicated by the motion vector applied to the target block may be the reference location of the target block. Hereinafter, the location indicated by the motion vector applied to the target block will be referred to in brief as “the reference location of the target block”. The reference location may indicate the reference block of the target block.

The location indicated by the motion vector or the reference location may be a location in a reference picture referred to by the target block.

In an embodiment, the inter-prediction unit 230 may add the motion information of the spatial candidate to the list if the reference location of the target block is present within a region. The inter-prediction unit 230 may not add the motion information of the spatial candidate to the list if the reference location of the target block is out of the region.

The region may be a region of a slice including the target block, a region of a tile including the target block, or a region of an MCTS including the target block.

In an embodiment, if the reference location of the target block is not out of a boundary, the inter-prediction unit 230 may add the motion information of the spatial candidate to the list. The inter-prediction unit 230 may not add the motion information of the spatial candidate to the list if the reference location of the target block is out of the region.

The boundary may include the boundary of the picture. Further, the boundary may include the boundary between slices, the boundary between tiles, or the boundary between MCTSs.

The spatial candidate may include multiple spatial candidates. The multiple spatial candidates may be A₁, B₁, B₀, A₀, and B₂.

If the number of pieces of motion information in the list is less than the preset maximum number of pieces of motion information, steps 1810 and 1820 may be sequentially and repeatedly performed on the multiple spatial candidates.

At step 1830, the inter-prediction unit 230 may determine whether the motion information of a temporal candidate is to be added to the list.

If it is determined that the motion information of the temporal candidate is to be added to the list, step 1840 may be performed.

If it is determined that the motion information of the temporal candidate is not to be added to the list, step 1850 may be performed.

At step 1840, if it is determined that the motion information of the temporal candidate is to be added to the list, the inter-prediction unit 230 may add the motion information of the temporal candidate to the list.

At steps 1830 and 1840, the motion information of the temporal candidate may be added to the list.

In an embodiment, at steps 1830 and 1840, the inter-prediction unit 230 may determine whether the motion information of the temporal candidate is to be added to the list, based on information about the target block and the motion information of the temporal candidate.

Hereinafter, the motion vector of the temporal candidate may be a scaled motion vector.

In an embodiment, the information about the target block may be the location of the target block. The inter-prediction unit 230 may determine whether the motion information of the temporal candidate is to be added to the list, based on the location of the target block and the motion vector of the temporal candidate.

In an embodiment, the inter-prediction unit 230 may determine whether the motion information of the temporal candidate is to be added to the list, based on the target block and a motion prediction boundary check for the temporal candidate.

In an embodiment, the inter-prediction unit 230 may determine whether the motion information of the temporal candidate is to be added to the list, based on a location indicated by a motion vector applied to the target block. Here, the applied motion vector may be the motion vector of the motion information of the temporal candidate.

The location indicated by the motion vector or the reference location may be a location in a reference picture referred to by the target block.

In an embodiment, the inter-prediction unit 230 may add the motion information of the temporal candidate to the list if the reference location of the target block is present within the region. The inter-prediction unit 230 may not add the motion information of the temporal candidate to the list if the reference location of the target block is out of the region.

In an embodiment, if the reference location of the target block is not out of the boundary, the inter-prediction unit 230 may add the motion information of the temporal candidate to the list. The inter-prediction unit 230 may not add the motion information of the temporal candidate to the list if the reference location of the target block is out of the region.

The temporal candidate may be the above-described first col block or second col block. When the first col block is available, the temporal candidate may be the first col block. When the second col block, rather than the first col block, is available, the temporal candidate may be the second col block. In other words, the first col block may be used with higher priority than the second col block.

If the number of pieces of motion information in the list is already identical to the preset maximum number of pieces of motion information before step 1830 is performed, steps 1830, 1840, 1850, 1860, 1870, and 1880 may not be performed, and the motion information of the temporal candidate may not be included in the list.

The above-described steps 1810, 1820, 1830, and 1840 may be replaced by a first step and a second step for multiple spatial candidates and temporal candidates.

At the first step, the inter-prediction unit 230 may determine whether the motion information of a candidate block is to be added to the list.

At the second step, if it is determined that the motion information of the candidate block is to be added to the list, the motion information may be added to the list.

The candidate block may include multiple spatial candidates and multiple temporal candidates.

The first step and the second step may be sequentially and repeatedly performed on the multiple spatial candidates and temporal candidates. The first and second step may be repeated until the first step has been performed on all of the multiple spatial candidates and temporal candidates, or until the number of pieces of motion information in the list reaches a preset maximum number.

In an embodiment, the inter-prediction unit 230 may determine whether the motion information of the candidate block is to be added to the list, based on the availability of the candidate block. If the candidate block is unavailable, the inter-prediction unit 230 may not add the motion information of the candidate block to the list. The inter-prediction unit 230 may add the motion information of the candidate block to the list if the candidate block is available and the motion information of the candidate block does not overlap other motion information present in the list.

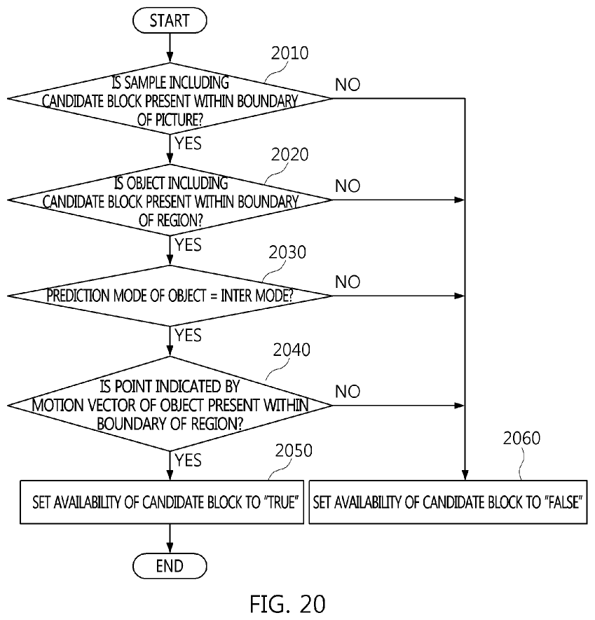

In an embodiment, determination of whether the motion vector is out of the boundary or determination corresponding thereto may be related to determination of availability. For example, even if the motion vector of the candidate block satisfies other conditions related to availability, the inter-prediction unit 230 may determine whether the candidate block is available depending on the results of a motion prediction boundary check. The determination of availability will be described in detail later with reference to FIG. 20.

In an embodiment, the determination of whether the motion vector is out of the boundary or the determination corresponding thereto may be separate from the determination of availability. For example, even if the candidate block is available, the inter-prediction unit 230, which determines the availability of the candidate block, may determine whether the motion information of the candidate block is to be added to the list depending on the results of the motion prediction boundary check.

If the number of pieces of motion information in the list reaches the preset maximum number before the first step and the second step are performed on all of the multiple spatial candidates and temporal candidates, an availability check may not be performed on the remaining candidates.

At step 1850, the inter-prediction unit 230 may determine whether combined motion information generated by combined bidirectional prediction is to be added to the list.

If it is determined that the combined motion information is to be added to the list, step 1860 may be performed.

If it is determined that the combined motion information is not to be added to the list, step 1870 may be performed.

At step 1860, if it is determined that the combined motion information is to be added to the list, the inter-prediction unit 230 may add the combined motion information to the list.

The inter-prediction unit 230 may add the combined motion information to the list 1) if the number of pieces of motion information in the list is less than the preset maximum number, 2) if combined motion information may be generated by combined bidirectional prediction that uses pieces of motion information in the list, and 3) if the combined motion information does not overlap other motion information in the list.

Here, each of the pieces of motion information in the list may be motion information that has already passed the motion prediction boundary check. Therefore, the combined motion information generated by combined bidirectional prediction that uses pieces of motion information in the list may pass the motion prediction boundary check. In contrast, the inter-prediction unit 230 may perform a motion prediction boundary check even on the combined motion information, and may add only the motion information that has passed the motion prediction boundary check to the list.

Steps 1850 and 1860 may be performed only when the type of target slice is “B”.

The combined motion information may include multiple pieces of combined motion information.

As described above, depending on the predefined sequence, multiple pieces of combined motion information may be generated. Steps 1850 and 1860 may be sequentially and repeatedly performed on the multiple pieces of combined motion information. Steps 1850 and 1860 may be repeated until all possible pieces of combined motion information have been added to the list, or until the number of pieces of motion information in the list reaches the preset maximum number.

At step 1870, the inter-prediction unit 230 may determine whether zero-vector motion information is to be added to the list.

If it is determined that zero-vector motion information is to be added to the list, step 1880 may be performed.

If it is determined that zero-vector motion information is not to be added to the list, the procedure may be terminated.

At step 1880, if it is determined that zero-vector motion information is to be added to the list, the inter-prediction unit 230 may add the zero-vector motion information to the list.

The inter-prediction unit 230 may add the zero-vector motion information to the list 1) if the number of pieces of motion information in the list is less than the preset maximum number, 2) if zero-vector motion information may be generated, and 3) if the zero-vector motion information does not overlap other motion information in the list.

The zero-vector motion information may include multiple pieces of zero-vector motion information.

Steps 1870 and 1880 may be sequentially and repeatedly performed on the multiple pieces of zero-vector motion information. Steps 1870 and 1880 may be repeated until all possible pieces of zero-vector motion information have been added to the list or until the number of pieces of motion information in the list reaches the preset maximum number.

FIG. 19 is a flowchart of a method for generating a predictive motion vector candidate list for inter prediction of a target block according to an embodiment.

Step S1730, described above with reference to FIG. 17, may include steps 1910, 1920, 1930, 1940, 1970, and 1980, which will be described below.

In the present embodiment, an intra-prediction mode for a target block may be an AMVP mode. A list may be a predictive motion vector candidate list. The motion information of a candidate block may correspond to a predictive motion vector candidate.

Steps 1910, 1920, 1930, 1940, 1970, and 1980 may correspond respectively to steps 1810, 1820, 1830, 1840, 1870, and 1880, described above with reference to FIG. 18. In other words, the descriptions of steps 1810, 1820, 1830, 1840, 1870, and 1880 may also be applied respectively to steps 1910, 1920, 1930, 1940, 1970, and 1980. Repeated descriptions thereof will be omitted, and the following description will be mainly made based on the differences between steps 1810, 1820, 1830, 1840, 1870, and 1880 and steps 1910, 1920, 1930, 1940, 1970, and 1980.

At step 1910, the inter-prediction unit 230 may determine whether the motion information of a spatial candidate is to be added to the list.

If it is determined that the motion information of the spatial candidate is to be added to the list, step 1920 may be performed.

If it is determined that the motion information of the spatial candidate is not to be added to the list, step 1930 may be performed.

The spatial candidate may include multiple spatial candidates. The multiple spatial candidates may include a first spatial candidate and a second spatial candidate. The first spatial candidate may be one of A₀, A₁, scaled A₀, and scaled A₁. The second spatial candidate may be one of B₀, B₁, B₂, scaled B₀, scaled B₁, and scaled B₂.

If the number of pieces of motion information in the list is less than the preset maximum number of pieces of motion information, steps 1910 and 1920 may be sequentially and repeatedly performed on the multiple spatial candidates.

At step 1930, the inter-prediction unit 230 may determine whether the motion information of a temporal candidate is to be added to the list.

If it is determined that the motion information of the temporal candidate is to be added to the list, step 1940 may be performed.

If it is determined that the motion information of the temporal candidate is not to be added to the list, step 1970 may be performed.

At step 1940, if it is determined that the motion information of the temporal candidate is to be added to the list, the inter-prediction unit 230 may add the motion information of the temporal candidate to the list.

At steps 1930 and 1940, the motion information of the temporal candidate may be added to the list.

If the number of pieces of motion information in the list is already identical to the preset maximum number before step 1930 is performed, steps 1930, 1940, 1970, and 1980 may not be performed, and the motion information of the temporal candidate may not be included in the list.

For example, if both the first spatial candidate and the second spatial candidate are available and the motion information of the first spatial candidate and the motion information of the second spatial candidate do not overlap each other, both the motion information of the first spatial candidate and the motion information of the second spatial candidate may be added to the list. In this case, if the preset maximum number is 2, the temporal candidate may not be derived, and the motion information of the temporal candidate may not be added to the list.

The above-described steps 1910, 1920, 1930, and 1940 may be replaced by a first step and a second step for multiple spatial candidates and temporal candidates.

At the first step, the inter-prediction unit 230 may determine whether the motion information of a candidate block is to be added to the list.

At the second step, if it is determined that the motion information of the candidate block is to be added to the list, the motion information may be added to the list.

At step 1970, the inter-prediction unit 230 may determine whether zero-vector motion information is to be added to the list.

If it is determined that zero-vector motion information is to be added to the list, step 1980 may be performed.

If it is determined that zero-vector motion information is not to be added to the list, the procedure may be terminated.

At step 1980, if it is determined that zero-vector motion information is to be added to the list, the inter-prediction unit 230 may add the zero-vector motion information to the list.

Steps 1970 and 1980 may be sequentially and repeatedly performed on multiple pieces of zero-vector motion information. Steps 1970 and 1980 may be repeated until all possible pieces of zero-vector motion information have been added to the list or until the number of pieces of motion information in the list reaches a preset maximum number.

FIG. 20 is a flowchart of a method for determining the availability of a candidate block for inter prediction of a target block according to an embodiment.

The candidate block may include the above-described spatial candidate and temporal candidate.

At step 2010, the inter-prediction unit 230 may check whether a sample including the candidate block is present within the boundary of a picture.

If it is determined that a sample including the candidate block is present within the boundary of the picture, step 2020 may be performed.

If no sample including the candidate block is present within the boundary of the picture, step 2060 may be performed.

At step 2020, the inter-prediction unit 230 may check whether an object including the candidate block is present within the boundary of a region.

The object including the candidate block may be a PU. In other words, an entity that provides the motion information may be a PU.

The region may be a region of a slice including the target block, a region of a tile including the target block, or a region of an MCTS including the target block.

If an object including the candidate block is present within the boundary of the region, step 2030 may be performed.

If no object including the candidate block is present within the boundary of the region, step 2060 may be performed.

The region may correspond to multiple regions among a region of a slice including the target block, a region of a tile including the target block, and a region of an MCTS including the target block. In this case, when the object including the candidate block is present within multiple boundaries of the multiple regions, step 2030 may be performed. When the object including the candidate block is not present within at least one of the multiple boundaries of the multiple regions, step 2060 may be performed.

At step 2030, the inter-prediction unit 230 may check whether the prediction mode of the object including the candidate block is an inter mode.

If the prediction mode of the object including the candidate block is the inter mode, step 2040 may be performed.

If the prediction mode of the object including the candidate block is not the inter mode, step 2060 may be performed.

At step 2040, the inter-prediction unit 230 may determine whether a point indicated by the motion vector of the object including the candidate block is present within the boundary of the region.

If it is determined that the point indicated by the motion vector of the object including the candidate block is present within the boundary of the region, step 2050 may be performed.

If it is determined that the point indicated by the motion vector of the object including the candidate block is not present within the boundary of the region, step 2060 may be performed.

At step 2050, the inter-prediction unit 230 may set the availability of the candidate block to “true”. In other words, the inter-prediction unit 230 may set the candidate block to be available.

At step 2060, the inter-prediction unit 230 may set the availability of the candidate block to “false”. In other words, the inter-prediction unit 230 may set the candidate block to be unavailable.

In other words, at steps 201, 2020, 2030, and 2040, the inter-prediction unit 230 may determine whether the candidate block is available, and at steps 2050 and 2060, the inter-prediction unit 230 may set the availability of the candidate block based on the results of the determination.

At step 2040, the availability of the candidate block may be determined based both on information about the target block and on the motion information of the object including the candidate block.

In an embodiment, the information about the target block may be the location of the target block. The inter-prediction unit 230 may determine whether the candidate block is available, based on the location of the target block and the motion vector of the object.

In an embodiment, the inter-prediction unit 230 may determine whether the candidate block is available, based on the target block and a motion prediction boundary check for the object.

In an embodiment, the inter-prediction unit 230 may determine whether the candidate block is available, based on the location indicated by a motion vector applied to the target block. Here, the applied motion vector may be the motion vector of the motion information of the object.

Here, the location indicated by the motion vector may be a location determined by adding the motion vector to the location of the target block.

Further, the location indicated by the motion vector applied to the target block may be the reference location of the target block.

The location indicated by the motion vector or the reference location may be a location in a reference picture referred to by the target block.

In an embodiment, the inter-prediction unit 230 may determine that the candidate block is available if the reference location of the target block is present within a region. The inter-prediction unit 230 may determine that the candidate block is unavailable if the reference location of the target block is out of the region.

The region may be a region of a slice including the target block, a region of a tile including the target block, or a region of an MCTS including the target block.

In an embodiment, the inter-prediction unit 230 may determine that the candidate block is available if the reference location of the target block is not out of a boundary. The inter-prediction unit 230 may determine that the candidate block is unavailable if the reference location of the target block is out of the region.

The boundary may include the boundary of the picture. The boundary may include the boundary between slices, the boundary between tiles, or the boundary between MCTSs.

The sequence of the above-described steps 2010, 2020, 2030, and 2040 is merely exemplary and may be arbitrarily changed.

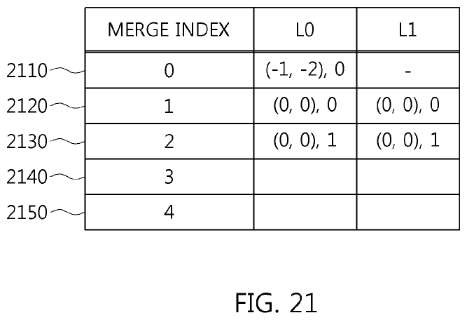

FIG. 21 illustrates a merge list to which a motion prediction boundary check according to an example is applied.

Referring to the merge list of FIG. 16, pieces of motion information in the second row 1620, the third row 1630, and the fourth row 1640 in the merge list may not pass the motion prediction boundary check, as described above with reference to FIG. 16. Therefore, the pieces of motion information in the second row 1620, the third row 1630, and the fourth row 1640 may not be added to the merge list of FIG. 21.

Further, the motion information in the fifth row 1650 is combined motion information generated by combined bidirectional prediction of the motion information in the first row 1610 and the motion information in the second row 1620. Since the motion information in the second row 1620 does not pass the motion prediction boundary check, the combined motion information in the fifth row 1650 cannot be generated.

Therefore, in the merge list of FIG. 21, only motion information corresponding to the first row 1610 may be present.

Since, among pieces of motion information of spatial candidates, pieces of motion information of temporal candidates, and pieces of combined motion information, the number of pieces of motion information added to the merge list is only one, zero-vector motion information may be added to the merge list.

When the number of reference pictures is 2, zero-vector motion information having a reference picture index of 0 and zero-vector motion information having a reference picture index of 1 may be added to the merge list.

As illustrated in FIG. 21, through the above-described embodiments, only the motion information that is not out of the boundary, among pieces of available motion information, may be added to the list, and the merge list may include only available motion information. In other words, compared to the merge list of FIG. 16, which includes only one piece of motion information that can actually be used, all of three pieces of motion information in the merge list of FIG. 21 may be effectively used. Therefore, encoding efficiency may be improved by the merge list of FIG. 21.

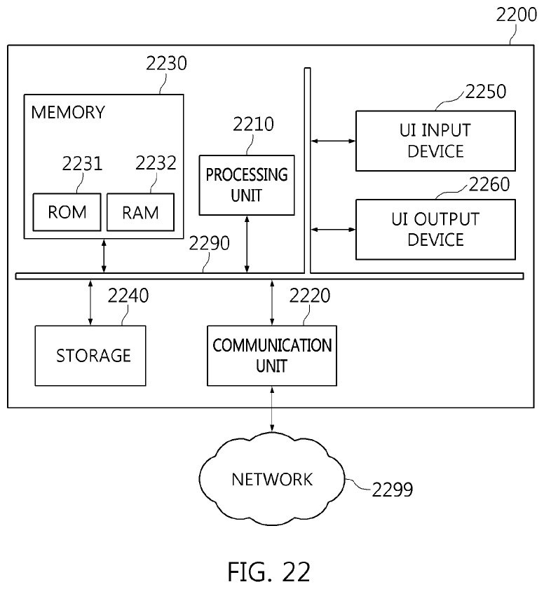

FIG. 22 is a configuration diagram of an electronic device in which the encoding apparatus is implemented according to an embodiment.

In an embodiment, at least some of the inter-prediction unit 110, the intra-prediction unit 120, the switch 115, the subtractor 125, the transform unit 130, the quantization unit 140, the entropy decoding unit 150, the inverse quantization unit 160, the inverse transform unit 170, the adder 175, the filter unit 180, and the reference picture buffer 190 of the encoding apparatus 100 may be program modules and may communicate with an external device or system. The program modules may be included in the encoding apparatus 100 in the form of an operating system, an application program module, and other program modules.

The program modules may be physically stored in various types of well-known storage devices. Further, at least some of the program modules may also be stored in a remote storage device that is capable of communicating with the encoding apparatus 100.

The program modules may include, but are not limited to, a routine, a subroutine, a program, an object, a component, and a data structure for performing functions or operations according to an embodiment or for implementing abstract data types according to an embodiment.

The program modules may be implemented using instructions or code executed by at least one processor of the encoding apparatus 100.

The encoding apparatus 100 may be implemented as an electronic device 2200 illustrated in FIG. 22. The electronic device 2200 may be a general-purpose computer system functioning as the encoding apparatus 100.

As shown in FIG. 22, the electronic device 2200 may include a processing unit 2210, memory 2230, a user interface (UI) input device 2250, a UI output device 2260, and storage 2240, which communicate with each other through a bus 2290. The electronic device 2200 may further include a communication unit 2220 connected to a network 2299.

The processing unit 2220 may be a Central Processing Unit (CPU) or a semiconductor device for executing processing instructions stored in the memory 2230 or the storage 2240. The processing unit 2220 may be at least one hardware processor.

The processing unit 2220 may generate and process the signals, data or information of the electronic device 2200, which are input to the electronic device 2200 or are output from the electronic device 2200, and may perform examination, comparison, and determination related to the signals, data or information. In other words, in an embodiment, the generation and processing of data or information and examination, comparison, and determination related to data or information may be performed by the processing unit 10.

For example, the processing unit 2220 may perform steps in FIGS. 17, 18, 19, and 20.

A storage unit may indicate the memory 2230 and/or the storage 2240. Each of the memory 2230 and the storage 2240 may be any of various types of volatile or nonvolatile storage media. For example, the memory may include at least one of Read Only Memory (ROM) 2231 and Random Access Memory (RAM) 2232.

The storage unit may store data or information used for the operation of the electronic device 2200. In an embodiment, the data or information of the electronic device 2200 may be stored in the storage unit.

For example, the storage unit may store pictures, blocks, lists, motion information, inter-prediction information, bitstreams, etc.

The electronic device 2200 may be implemented in a computer system including a computer-readable storage medium.

The storage medium may store at least one module required in order for the electronic device 2200 to function as the encoding apparatus 100. The memory 2230 may store at least one module and may be configured to be executed by the processing unit 2210.

Functions related to communication of data or information of the electronic device 2200 may be performed by the communication unit 2220.

For example, the communication unit 2220 may transmit a bitstream including inter-prediction information or the like to the decoding apparatus 200.

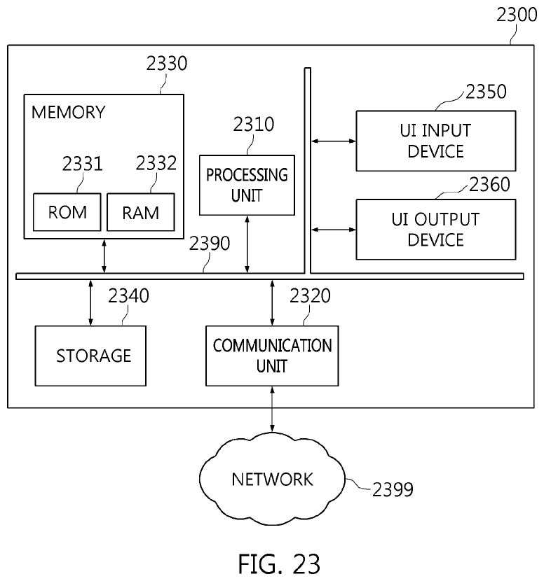

FIG. 23 is a configuration diagram of an electronic device in which the decoding apparatus is implemented according to an embodiment.

In an embodiment, at least some of the entropy decoding unit 210, the inverse quantization unit 220, the inverse transform unit 230, the intra-prediction unit 240, the inter-prediction unit 250, the adder 255, the filter unit 260, and the reference picture buffer 270 of the decoding apparatus 200 may be program modules and may communicate with an external device or system. The program modules may be included in the decoding apparatus 200 in the form of an operating system, an application program module, and other program modules.

The program modules may be physically stored in various types of well-known storage devices. Further, at least some of the program modules may also be stored in a remote storage device that is capable of communicating with the decoding apparatus 200.

The program modules may include, but are not limited to, a routine, a subroutine, a program, an object, a component, and a data structure for performing functions or operations according to an embodiment or for implementing abstract data types according to an embodiment.

The program modules may be implemented using instructions or codes executed by at least one processor of the decoding apparatus 200.

The decoding apparatus 200 may be implemented as an electronic device 2300 illustrated in FIG. 23. The electronic device 2300 may be a general-purpose computer system functioning as the encoding apparatus 100.

As shown in FIG. 23, the electronic device 2300 may include a processing unit 2310, memory 2330, a UI input device 2350, a UI output device 2360, and storage 2340, which communicate with each other through a bus 2390. The electronic device 2300 may further include a communication unit 2320 connected to a network 2399.

The processing unit 2320 may be a CPU or a semiconductor device for executing processing instructions stored in the memory 2330 or the storage 2340. The processing unit 2320 may be at least one hardware processor.

The processing unit 2320 may generate and process the signals, data or information of the electronic device 2300, which are input to the electronic device 2300 or are output from the electronic device 2300, and may perform examination, comparison, and determination related to the signals, data or information. In other words, in an embodiment, the generation and processing of data or information, and examination, comparison, and determination related to data or information may be performed by the processing unit 10.

For example, the processing unit 2320 may perform steps in FIGS. 17, 18, 19, and 20.

A storage unit may indicate the memory 2330 and/or the storage 2340. Each of the memory 2330 and the storage 2340 may be any of various types of volatile or nonvolatile storage media. For example, the memory may include at least one of Read Only Memory (ROM) 2331 and Random Access Memory (RAM) 2332.

The storage unit may store data or information used for the operation of the electronic device 2300. In an embodiment, the data or information of the electronic device 2300 may be stored in the storage unit.

For example, the storage unit may store pictures, blocks, lists, motion information, inter-prediction information, bitstreams, etc.

The electronic device 2300 may be implemented in a computer system including a computer-readable storage medium.

The storage medium may store at least one module required in order for the electronic device 2300 to function as the decoding apparatus 200. The memory 2330 may store at least one module and may be configured to be executed by the processing unit 2310.

Functions related to communication of data or information of the electronic device 2300 may be performed by the communication unit 2320.

For example, the communication unit 2320 may receive a bitstream including inter-prediction information or the like from the encoding apparatus 100.

In the above-described embodiments, although the methods have been described based on flowcharts as a series of steps or units, the present invention is not limited to the sequence of the steps and some steps may be performed in a sequence different from that of the described steps or simultaneously with other steps. Further, those skilled in the art will understand that the steps shown in the flowchart are not exclusive and may further include other steps, or that one or more steps in the flowchart may be deleted without departing from the scope of the invention.

The above-described embodiments according to the present invention may be implemented as a program that can be executed by various computer means and may be recorded on a computer-readable storage medium. The computer-readable storage medium may include program instructions, data files, and data structures, either solely or in combination. Program instructions recorded on the storage medium may have been specially designed and configured for the present invention, or may be known to or available to those who have ordinary knowledge in the field of computer software. Examples of the computer-readable storage medium include all types of hardware devices specially configured to record and execute program instructions, such as magnetic media, such as a hard disk, a floppy disk, and magnetic tape, optical media, such as compact disk (CD)-ROM and a digital versatile disk (DVD), magneto-optical media, such as a floptical disk, ROM, RAM, and flash memory. Examples of the program instructions include machine code, such as code created by a compiler, and high-level language code executable by a computer using an interpreter. The hardware devices may be configured to operate as one or more software modules in order to perform the operation of the present invention, and vice versa.

As described above, although the present invention has been described based on specific details such as detailed components and a limited number of embodiments and drawings, those are merely provided for easy understanding of the entire invention, the present invention is not limited to those embodiments, and those skilled in the art will practice various changes and modifications from the above description.

Accordingly, it should be noted that the spirit of the present embodiments is not limited to the above-described embodiments, and the accompanying claims and equivalents and modifications thereof fall within the scope of the present invention.

1. A list generation method for generating a list for inter prediction of a target block, comprising:
determining whether motion information of a candidate block is to be added to a list; and
if it is determined that the motion information is to be added to the list, adding the motion information to the list,
wherein whether the motion information is to be added to the list is determined based on information about the target block and the motion information.

2. The list generation method of claim 1, wherein the information about the target block is a location of the target block.

3. The list generation method of claim 1, wherein whether the motion information is to be added to the list is determined based on a motion vector of the motion information.

4. The list generation method of claim 1, wherein whether the motion information is to be added to the list is determined based on a location indicated by a motion vector of the motion information applied to the target block.

5. The list generation method of claim 4, wherein the location indicated by the motion vector is a location in a reference picture referred to by the target block.

6. The list generation method of claim 4, wherein if the location is present within a region, the motion information is added to the list, whereas if the location is out of the region, the motion information is not added to the list.

7. The list generation method of claim 6, wherein the region is a region of a slice including the target block, a region of a tile including the target block, or a region of a Motion-Constrained Tile Set (MCTS) including the target block.

8. The list generation method of claim 4, wherein if the location is not out of a boundary, the motion information is added to the list, whereas if the location is out of the boundary, the motion information is not added to the list.

9. The list generation method of claim 8, wherein:
the boundary includes a boundary of a picture, and
the boundary includes a boundary between slices, a boundary between tiles, or a boundary between MCTSs.

10. The list generation method of claim 1, wherein:
an intra-prediction mode of the target block is a merge mode or a skip mode, and
the list is a merge list.

11. The list generation method of claim 1, wherein:
an intra-prediction mode of the target block is an Advanced Motion Vector Predictor (AMVP) mode, and
the list is a predictive motion vector candidate list.

12. The list generation method of claim 1, wherein the candidate block includes multiple spatial candidates and temporal candidates.

13. The list generation method of claim 1, wherein if the candidate block is available and the motion information of the candidate block does not overlap other motion information present in the list, the motion information of the candidate block is added to the list.

14. The list generation method of claim 1, wherein even if the candidate block is a first available candidate block, the motion information of the candidate block is not added to the list when the information about the target block and the motion information satisfy specific conditions.

15. A list generation apparatus for generating a list for inter prediction of a target block, comprising:
a processing unit for determining whether motion information of a candidate block is to be added to the list, based on based on information about the target block and the motion information of the candidate block; and
a storage unit for storing the list.

16. A method for setting availability of a candidate block for inter prediction of a target block, comprising:
determining whether the candidate block is available; and
setting availability of the candidate block based on results of the determination,
wherein the availability is set based on information about a target block and motion information of an object including the candidate block.

17. The method of claim 16, wherein the object is a Prediction Unit (PU).

18. The method of claim 16, wherein whether the candidate block is available is determined based on a motion vector of the motion information.

19. The method of claim 16, wherein whether the candidate block is available is determined based on a location indicated by a motion vector of the motion information applied to the target block.

20. The method of claim 19, wherein if the location is present within a region, the candidate block is set to be available, whereas if the location is out of the region, the candidate block is set to be unavailable.
